(19) United States
(12) Patent Application Publication
(10) Pub. No.: US 2022/0032758 A1
(43) Pub. Date: Feb. 3, 2022

(54) VEHICLE BODY STRUCTURE

(71) Applicant: HONDA MOTOR CO., LTD., Minato-ku, Tokyo (JP)

(72) Inventors: Kanji KANEKO, Wako-shi, Saitama (JP); Kazuhiro SAKAI, Wako-shi, Saitama (JP); Takehiko KOSHIISHI, Wako-shi, Saitama (JP); Satoru NOGUCHI, Wako-shi, Saitama (JP)

(21) Appl. No.: 17/279,750

(22) PCT Filed: Sep. 27, 2018
(86) PCT No.: PCT/JP2018/036087

§ 371 Date: Mar. 25, 2021

(51) Int. Cl. B60K 1/04; B62D 21/04; B62D 21/06; B62D 21/15

(52) U.S. Cl. CPC B60K 1/04; B62D 21/04; B62D 21/06; B60K 2001/0411; B60K 2001/0438; B60K 2001/0422; B62D 21/152

(57) ABSTRACT

In a vehicle body structure configured to place a battery in a lower part of a cabin, the loading of a frontal crash and a rear end crash that may be applied to the battery is minimized. The vehicle body structure (1), comprises a pair of side sills (3) extending in a fore and aft direction on either side of a vehicle (2), a pair of front side frames (4) extending in the fore and aft direction along either side of a front part of the vehicle, and connected to front ends of the side sills at rear ends thereof, respectively, a pair of rear side frames (71) extending in the fore and aft direction along either side of a rear part of the vehicle, and connected to rear ends of the side sills at front ends thereof, respectively, a front subframe (6) attached to the front side frames, a rear subframe (72) attached to the rear side frames, and a battery (140) positioned in a region surrounded by the side sills, the front subframe and the rear subframe in plan view.

### TECHNICAL FIELD

The present invention relates to a vehicle body structure, and more particularly to a vehicle body structure including a floor panel configured to place a battery thereunder.

### BACKGROUND ART

A known vehicle body structure for a four-wheeled vehicle includes a pair of side frames extending in a fore and aft direction on either side thereof, and a front subframe attached to lower parts of the front side frames (See Patent Document 1, for instance). A pair of front wheels are attached to the front subframe via respective suspension device devices, and a power train such as an internal combustion engine and an electric motor, a steering gear box, and the like are also attached to the front subframe. The junctions between the front subframe and the front side frames are configured to be deformed so as to cause the front side frames to be detached from the front subframe when subjected to a loading of a frontal crash.

### PRIOR ART DOCUMENT(S)

### Patent Document(s)

Patent Document 1: JP2013-119359A

### SUMMARY OF THE INVENTION

### Task to be Accomplished by the Invention

In an electric vehicle or a hybrid vehicle, a battery may be placed under a floor panel forming the floor of a cabin. In such a vehicle body structure, in order to minimize the loading of a frontal crash and a rear end crash that may be applied to the battery, it is required that the in the fore and aft direction parts of the vehicle body is able to absorb the adequately absorb the crash load.

### SUMMARY OF THE INVENTION

In view of such a problem of the prior art, a primary object of the present invention is to provide a vehicle body structure configured to place a battery in a lower part of a cabin so as to minimize the loading of a frontal crash and a rear end crash that may be applied to the battery.

To achieve such an object, the present invention provides a vehicle body structure, comprising:

a pair of side sills (3) extending in a fore and aft direction on either side of a vehicle (2);

a pair of front side frames (4) extending in the fore and aft direction along either side of a front part of the vehicle, and connected to front ends of the side sills at rear ends thereof, respectively;

a pair of rear side frames (71) extending in the fore and aft direction along either side of a rear part of the vehicle, and connected to rear ends of the side sills at front ends thereof, respectively;

a front subframe (6) attached to the front side frames;

a rear subframe (72) attached to the rear side frames; and

a battery (140) positioned in a region surrounded by the side sills, the front subframe and the rear subframe in plan view.

According to this configuration, the load of a frontal crash is transmitted to the side sills via the front subframes, and is prevented from being transmitted to the battery. Further, the front subframe attached to the front side frames absorbs the load of the frontal crash so that the load of the frontal crash is prevented from being transmitted to the battery. The load of a rear end crash is transmitted to the side sills via the rear side frames, and is prevented from being transmitted to the battery. Further, the rear subframe attached to the rear side frames absorbs the load of the rear end crash so that the load of the rear end crash is prevented from being transmitted to the battery. Since the battery is positioned in a relatively spacious region surrounded by the side sills, the front subframe, and the rear subframe, the size of the battery can be increased.

In this vehicle body structure, preferably, the front subframe includes a pair of front longitudinal members (23) extending in the fore and aft direction on either side thereof, each front longitudinal member being provided with a front end attaching portion (23A) attached to the corresponding front side frame at a front end thereof, and a pair of rear longitudinal members (91) extending in the fore and aft direction on either side of the vehicle, each rear longitudinal member being provided with a rear end attaching portion (91E) attached to the corresponding rear side frame at a rear end thereof. Each front end attaching portion may be either directly attached to the front subframe or indirectly attached to the front subframe via another member, and each rear end attaching portion may be either directly attached to the rear subframe or indirectly attached to the rear subframe via another member.

According to this configuration, the front subframe can receive the load at the front end in the case of a frontal crash, and can efficiently absorb the load. In addition, the rear subframe can receive a load from the rear end in a rear end crash, and can efficiently absorb the load.

In this vehicle body structure, preferably, one of the front subframe and the rear subframe supports a drive unit (75), and is provided with a pair of subframe longitudinal members (91) extending in the fore and aft direction along either side thereof, and a subframe cross member (92, 93) extending laterally between the subframe longitudinal members and attached to the front side frames or the rear side frames, as the case may be, and another of the front subframe and the rear subframe does not support the drive unit, and is attached to the front side frames or the rear side frames, as the case may be, so as to be detachable under a crash load.

According to this configuration, the subframe on which the drive unit is mounted can be attached to the front side frames or the rear side frames with an increased strength. As a result, the drive unit can be better protected, and the transmission of a load from the subframe on which the drive unit is mounted to the battery can be minimized. Further, since the subframe on which the drive unit is not mounted can be detached or dislodged upon receiving a crash load, transmission of the load from the subframe to the battery can be prevented.

In this vehicle body structure, preferably, the front side frames and the rear side frames are each provided with a longitudinal extension (4A, 71C) extending in the fore and aft direction, and a rear or front end of the longitudinal extension is provided with an oblique portion (4C, 71A) extending laterally outward and rearward or forward, as the case may be, to be connected to a corresponding end part of the corresponding side sill.

According to this configuration, the frontal crash load applied to the front side frames can be transmitted to the side sills. Further, the rear end crash load applied to the rear side frames can be transmitted to the side sills. Thus, transmission of load to the battery at the time of a crash can be minimized.

Preferably, this vehicle body structure further comprises a vehicle body cross member (77) extending laterally between the oblique portions of the front side frames or the rear side frames corresponding to one of the front subframe and the rear subframe supporting the drive unit, and a pair of load transmitting members (80) each extending from the longitudinal extension of the corresponding front side frame or the corresponding rear side frame associated with one of the front subframe and the rear subframe supporting the drive unit to the vehicle body cross member via a laterally inboard side of the corresponding oblique member.

According to this configuration, the load applied to the front side frames or the rear side frames associated with the subframe on which the drive unit is mounted is transmitted to the vehicle body cross member via the load transmitting members. Thereby, the deformation of the front side frames or the rear side frames is reduced with the result that the drive unit mounted on the subframe can be favorably protected.

In this vehicle body structure, preferably, the load transmitting members are inclined laterally inward from the respective longitudinal extensions toward the vehicle body cross member.

According to this configuration, the load applied to the front side frames or the rear side frames can be widely distributed to the side sills and the cross member so that deformation of the front side frames or the rear side frames can be reduced.

In this vehicle body structure, preferably, the drive unit is supported by the rear subframes, a floor panel (78) is supported by upper surfaces of the rear side frames, and the load transmitting members each form a closed cross section structure jointly with the corresponding rear side frame and the floor panel.

According to this configuration, the rigidity of the load transmitting members can be improved.

In this vehicle body structure, preferably, each closed cross section structure formed by the load transmitting member, the rear side frame and the floor panel is internally provided with a bulkhead (81) connected to the load transmitting member and the rear side frame, and the subframe longitudinal members of the rear side frames are each attached to a vehicle body side mounting portion including the bulkhead.

According to this configuration, the rigidity of the vehicle body side mounting portion can be improved.

In this vehicle body structure, preferably, each vehicle body side mounting portion includes a collar (85B) that extends vertically and connected to the load transmitting member and the bulkhead.

According to this configuration, the rigidity of the vehicle body side mounting portion can be improved.

In this vehicle body structure, preferably, the subframe cross member includes a pair of longitudinal member connecting portions (93B) connected to the respective subframe longitudinal members, a pair of cross member extensions (93C) extending laterally outward and upward from the respective longitudinal member connecting portions, and a pair of outer end mounting portions (104) attached to the corresponding front side frames or the corresponding rear side frames.

According to this configuration, a lateral load input from the suspension device arm to each longitudinal member can be transmitted to the corresponding rear side frame via the longitudinal member connecting portion, the cross member extension, and the outer end mounting portion on the corresponding side in this order. As a result, the rigidity of the rear subframes against a lateral load from the corresponding suspension device arm can be improved.

In this vehicle body structure, preferably, a vertical width of the subframe cross member is at a maximum value at the longitudinal member connecting portions.

According to this configuration, the rigidity of the longitudinal member connecting portions can be improved, and the rigidity of the longitudinal members can be improved so that the longitudinal members are favorably reinforced against a relatively large lateral force that may be applied in an early stage of a crash.

In this vehicle body structure, preferably, a vertical width of each cross member extension is progressively reduced toward a lateral outer end thereof.

Thereby, stress concentration in the cross member extension can be minimized.

In this vehicle body structure, preferably, each longitudinal member connecting portion includes a through hole (93A) passed through the subframe cross member in the fore and aft direction, and the corresponding subframe longitudinal member is inserted in the through hole, and is welded to the subframe cross member.

According to this configuration, the rigidity of the longitudinal member connecting portion can be improved.

In this vehicle body structure, preferably, the subframe cross member is provided with an upper surface central portion (93D) having a surface facing upward and extending laterally,

a pair of upper surface inclined portions (93F) each extending from a corresponding end of the upper surface central portion via an upper surface curved portion (93E),

a lower surface central portion (93G) having a surface facing downward and extending laterally, and

a pair of lower surface inclined portions (93J) each extending from a corresponding end of the lower surface central portion via a lower surface curved portion (93H), the upper surface curved portions being position laterally inward of the longitudinal member connecting portions, and the lower surface curved portions being position laterally outward of the longitudinal member connecting portions.

According to this configuration, the parts of the subframe cross member where the longitudinal member connecting portions are provided can have a large vertical width. Since the curvature of the upper surface curved portions can be reduced as compared with that of the lower surface curved portions, the lateral force applied to the longitudinal members can be efficiently transmitted to the rear side frames via the corresponding cross member extensions.

In this vehicle body structure, preferably, the subframe cross member is provided with an upper member (94A) having a channel shaped cross section with an open side facing downward, and a lower member (94B) having a channel shaped cross section with an open side facing upward, and forming a closed cross section structure jointly with the upper member, and the upper member forms the upper surface central portion, the upper surface curved portions, and the upper surface inclined portions while the lower member forms the lower surface central portion, the lower surface curved portions, and the lower surface inclined portions.

According to this configuration, the subframe cross member can be formed with a simple structure.

In this vehicle body structure, preferably, each lower surface inclined portion includes a reinforcing bead (93K) extending from the corresponding lower surface curved portion toward the outer end mounting portion.

According to this configuration, the rigidity of the lower curved portions and the lower inclined portions can be improved.

Preferably, this vehicle body structure further comprises a rear panel (88) extending laterally and connected to rear end parts of the rear side frames.

According to this configuration, the rigidity of the rear side frames in the lateral direction is improved so that the rear side frames are less likely to be deformed by a lateral force transmitted through the longitudinal members and the subframe cross member of the rear subframe.

In this vehicle body structure, preferably, the rear panel (88) is provided with a recess (88A) which is recessed upward in a lower edge part thereof.

According to this configuration, the projection 93L of each rear subframe 72 can be made to project rearward of the rear panel 88 via the recess 88A without interfering with the rear panel 88.

In this vehicle body structure, preferably, the front subframe includes a pair of front longitudinal members (23) extending in the fore and aft direction on either lateral side thereof, and a front subframe cross member (24) extending laterally between the front longitudinal members, the front longitudinal members being inclined so as to come toward each other toward rear ends thereof.

According to this configuration, the load applied to the front ends of the front longitudinal members at the time of a frontal crash can be transmitted in obliquely inward directions so that the load can be widely distributed.

Preferably, this vehicle body structure further comprises a pair of front subframe rear end support portions (21) provided on the laterally inner sides of the respective front side frames,

wherein each front subframe rear end support portion is provided with a fastening portion (4D) to which the corresponding front side frame is fastened, and a guide portion (19) positioned behind the fastening portion and having an inclined surface (19A) inclining downward toward a rear side, and

each front longitudinal member is fastened to the corresponding fastening portion from below by a bolt at a rear side fastening portion thereof positioned a certain distance in front of a rear end thereof.

According to this configuration, at least one of the fastening portions, the bolts, and the rear side fastening portions is deformed by the load of a frontal crash so that the rear end of at least one of the front longitudinal members can be detached from the corresponding rear side frame. Once detached from the rear side frame, the rear end of the front longitudinal member is guided downward by the guide portion so as to be prevented from colliding with the battery. In addition, since the front subframe rear end support portions are position on the laterally inside of the respective front side frames, the deformation of the rear end support portions of the front subframes is prevented from interfering with the deformation of the front side frames.

In this vehicle body structure, preferably, a part of each front longitudinal member located in front of the rear side fastening portion is provided with a deformation promoting portion (53) providing a starting point of downward deformation when a predetermined load is applied from the fore and aft direction.

According to this configuration, by bending the front longitudinal member downward, the rear end of the front longitudinal member is turned so as to promote the deformation of the fastening portion, the bolt and the rear side fastening portion.

In this vehicle body structure, preferably, each deformation promoting portion is provided with a recessed portion formed on an upper surface of the corresponding front longitudinal member.

According to this configuration, the downward bending deformation of the front longitudinal member can be caused in a reliable manner by using a simple structure.

In this vehicle body structure, preferably, each deformation promoting portion includes a high rigidity portion (54, 56) having a higher rigidity than the recessed portion in front of and behind the recessed portion.

According to this configuration, the stress can be concentrated in the deformation promoting portion so that the deformation of the deformation promoting portion can be ensured in a reliable manner.

In this vehicle body structure, preferably, one of the high rigidity portions includes a stabilizer attachment portion (56) for supporting a front stabilizer, and a cross member connecting portion to which an end of the front subframe cross member is connected.

According to this configuration, by making use of the stabilizer attachment portion and the front subframe cross member, the high rigidity portion can be formed without adding an extra high rigidity member.

### Effect of the Invention

The present invention thus provides a vehicle body structure configured to place a battery in a lower part of a cabin so as to minimize the loading of a frontal crash and a rear end crash that may be applied to the battery.

### BRIEF DESCRIPTION OF THE DRAWING(S)

FIG. 1 is a bottom view of a vehicle body structure according to an embodiment of the present invention;

FIG. 2 is a bottom view of the vehicle body structure with a front subframe and a rear subframe omitted from illustration;

FIG. 3 is a side view of a front part of the vehicle body structure;

FIG. 4 is a bottom view of the front part of the vehicle body structure;

FIG. 5 is a perspective view of the front subframe;

FIG. 6 is a left side view of the front subframe;

FIG. 7 is a sectional view showing a fastening structure between a rear end portion of a front longitudinal member and a rear end supporting portion in the front subframe;

FIG. 8 is a plan view of the front subframe;

FIG. 9 is a perspective view showing a connecting structure between a rear side frame, a vehicle body cross member and a load transmitting member with a rear floor panel omitted from illustration;

FIG. 10 is a sectional view of the connecting structure between the rear side frame, the vehicle body cross member and the load transmitting member;

FIG. 11 is a perspective view of a rear subframe;

FIG. 12 is a plan view of the rear subframe;

FIG. 13 is a sectional view taken along line XIII-XIII of FIG. 12;

FIG. 14 is a rear view of a rear left end part of the rear subframe (as seen in the direction indicated by arrow XIV of FIG. 12);

FIG. 15 is a bottom perspective view of the rear left end part of the rear subframe;

FIG. 16 is a sectional view taken along line XVI-XVI of FIG. 12;

FIG. 17 is a sectional view taken along line XVII-XVII of FIG. 12;

FIG. 18 is a left side view of a rear part of the vehicle body structure (with a left side view of the rear side frame omitted from illustration;

FIG. 19 is a perspective view of a left end of a rear part of the vehicle body structure;

FIG. 20 is a cross sectional view of a shock absorbing structure; and

FIG. 21 is an explanatory view of a rear part of the vehicle body structure showing the positioning of an electric motor.

### DESCRIPTION OF THE PREFERRED EMBODIMENT(S)

A vehicle body structure according to the present invention is described in the following. In the following description, the fore and aft direction, the lateral direction (vehicle width direction), and the vertical direction are defined with respect to the vehicle. The inboard direction (laterally inward direction) refers to a direction approaching the center of the vehicle in the lateral direction, and the outboard direction (laterally outward direction) refers to a direction away from the center of the vehicle in the lateral direction. The frames, panels and various other members forming the vehicle body structure are made of steel unless otherwise specified.

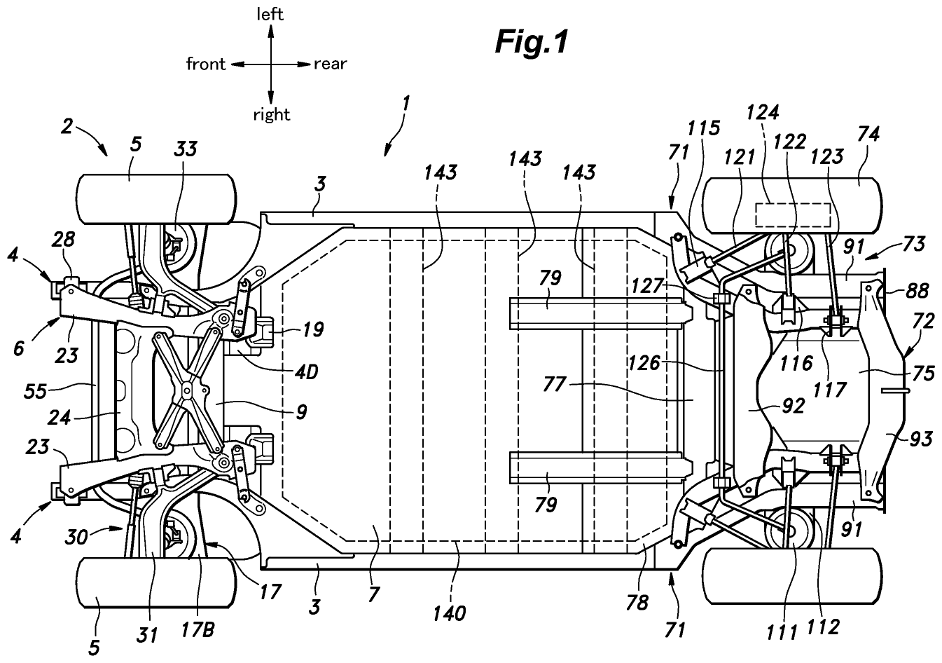

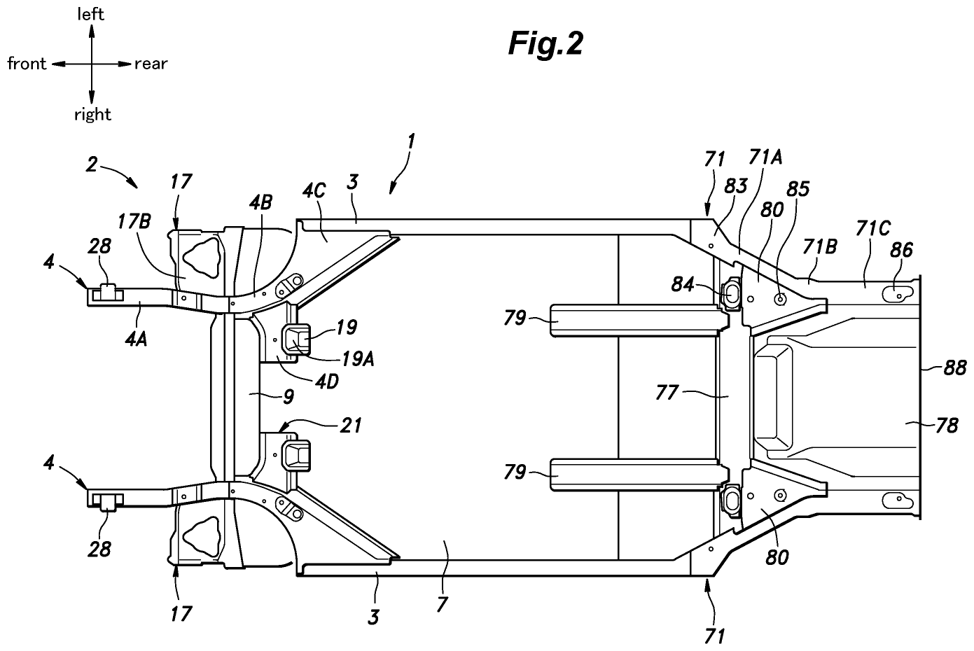

As shown in FIGS. 1 and 2, the vehicle body structure 1 includes a pair of side sills 3 extending in the fore and aft direction along either side of a lower part of the vehicle 2, a pair of front side frames 4 extending along either side of a front part of the vehicle 2 and connected to the front ends of the side sills 3 at the rear ends thereof, respectively, and a front subframe 6 attached to the lower side of the left and right front side frames 4, respectively, for supporting the front wheels 5.

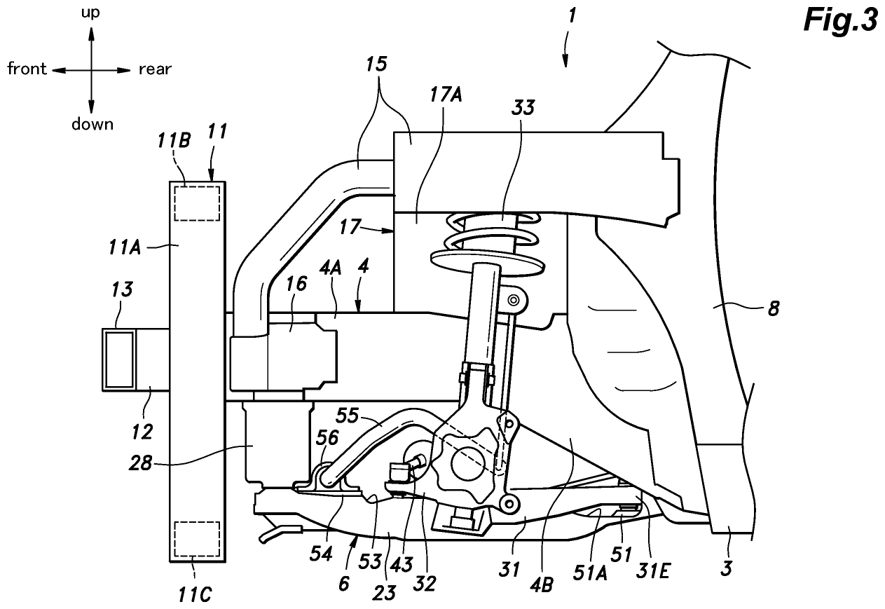

A front floor panel 7 having a vertically facing major plane extends between the upper surfaces of the left and right side sills 3. As shown in FIG. 3, a pair of front pillars 8 are provided at the front ends of the respective side sills 3. Each front pillar 8 extends vertically and is connected to the front end of the corresponding side sill 3 at the lower end thereof. As shown in FIGS. 1 and 2, a dash panel 9 having a major surface facing in the fore and aft direction is provided between the left and right front pillars 8. The dash panel 9 is connected to left and right front pillars 8 at the left and right side edges thereof, respectively, and is connected to a front edge of the front floor panel 7 at the lower edge thereof.

As shown in FIGS. 1 to 4, each front side frame 4 includes a front side frame front portion 4A extending in the fore and aft direction laterally more inward and more upward than the corresponding side sill 3, a front side frame intermediate portion 4B extending from the rear end of the front side frame front portion 4A in a rearward and downward direction, and a front side frame oblique portion 4C (outrigger) extending in a rearward and laterally outward direction from the rear end of the front side frame intermediate portion 4B and connected to the front end of the corresponding side sill 3.

The front side frame intermediate portion 4B has a hat-shaped cross section having an open side facing upward, and is attached to the lower front surface of the dash panel 9 to form a closed cross section structure in cooperation with the dash panel 9. The front side frame oblique portion 4C has a hat-shaped cross section having an open side facing upward, and is attached to the lower surface of the front floor panel 7 to form a closed cross-section structure in cooperation with the front floor panel 7. The front side frame oblique portion 4C has a progressively increasing fore and aft width toward the outboard side thereof, and is attached to the inboard side surface of the corresponding side sill 3 at the outboard end thereof.

As shown in FIG. 3, a bulkhead 11 is provided at the front ends of the front side frame front portions 4A. The bulkhead 11 includes a pair of bulkhead side members 11A extending vertically along either side thereof, a bulkhead upper member 11B extending laterally between the upper ends of the bulkhead side members 11A, and a bulkhead lower member 11C extending laterally between the lower ends of the bulkhead side members 11A, thus forming a rectangular frame shape. The front ends of the front side frame front portions 4A are connected to the vertically middle parts of the rear surfaces of the bulkhead side members 11A, respectively.

A laterally extending front bumper beam 13 is attached to the bulkhead side members 11A via respective frontal crash boxes 12 serving as shock absorbers. Each frontal crash box 12 is formed in a cylindrical shape extending in the fore and aft direction, and is connected to a vertically intermediate part of the corresponding bulkhead side member 11A at the rear end thereof, and to the rear surface of the front bumper beam 13 at the front end thereof. The frontal crash box 12 has a lower fore and aft rigidity than the front side frames 4, the front bumper beam 13, and the bulkhead 11 so as to be deformed earlier than the front side frames 4 and the associated members, and favorably absorbs the impact when a load at the time of a frontal crash is applied thereto.

The upper part of each front pillar 8 is provided with a front upper member 15 which extends forward and then in a forward and downward direction. The front upper members 15 are disposed laterally outward and upward relative to the corresponding front side frame front portions 4A. The front end of each front upper member 15 is connected to the front end of the corresponding front side frame front portion 4A via a laterally extending connecting member 16. A front damper housing 17 is provided between each front side frame front portion 4A and the corresponding front upper member 15. Each front damper housing 17 is provided with a vertical wall portion 17A extending upward from a rear part of the corresponding front side frame front portion 4A, and an upper wall portion 17B extending laterally outward from an upper end of the vertical wall portion 17A to be joined to the corresponding front upper member 15 at the laterally outer end thereof.

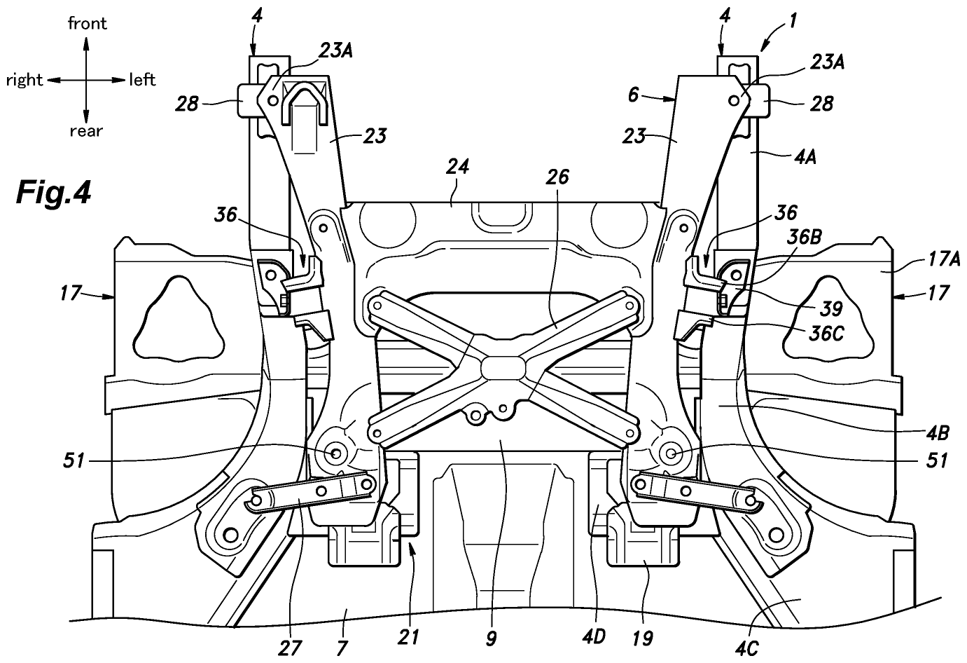

As shown in FIG. 4, each front side frame intermediate portion 4B is provided with a lateral extension 4D extending laterally inward. The inner ends of the lateral extensions 4D laterally oppose each other with a gap defined therebetween. The outer ends of the left and right lateral extensions 4D are connected to the inner sides of the respective front side frame intermediate portions 4B. Each lateral extension 4D has a hat-shaped cross section having an open side facing upward to forms closed cross section structure in cooperation with the floor panel. Each lateral extension 4D forms a part of the respective front side frame 4.

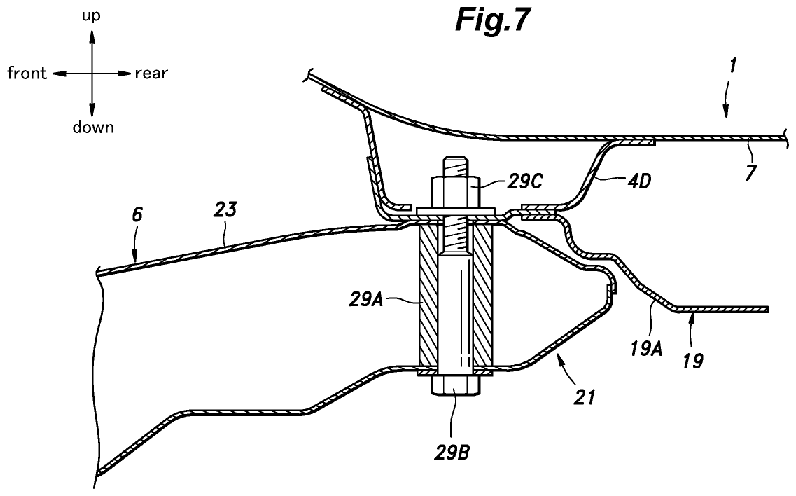

As shown in FIGS. 4 and 7, the inner end of each lateral extension 4D is fitted with a guide member 19 that extends rearward from the lower surface of the inner side of the lateral extension 4D. The guide member 19 is provided with an inclined surface 19A that is inclined downward toward the rear in a front lower part thereof. Each lateral extension 4D and the corresponding guide member 19 jointly form a rear end support portion 21 that supports the rear end of the front subframe 6 on the corresponding side. The lateral extension 4D functions as a fastening seat to which the rear end of the corresponding front subframe 6 is fastened.

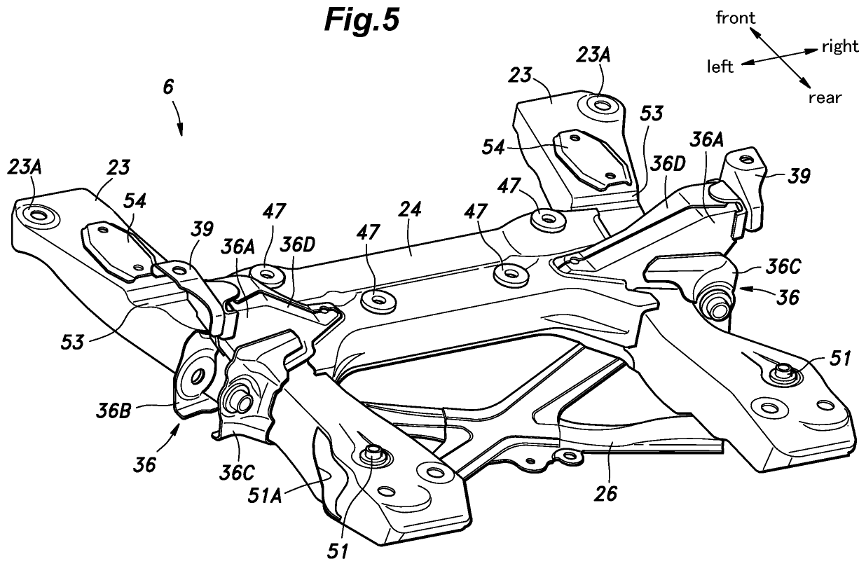

As shown in FIGS. 4 and 5, the front subframe 6 includes a pair of front longitudinal members 23 extending in the fore and aft direction along either side thereof, and a front cross member 24 extending laterally between the front longitudinal members 23. The front longitudinal members 23 are inclined inward toward the rear ends thereof so as to come closer to each other toward the rear end thereof. The laterally outer edge of each front longitudinal member 23 is curved so that the fore and aft central part of the front longitudinal member 23 is recessed inward.

The left and right ends of the front cross member 24 are joined to the fore and aft intermediate parts of the respective front longitudinal members 23. The left and right ends of the front cross member 24 are connected to the parts of the respective front longitudinal members 23 positioned somewhat forward of the fore and aft central points thereof. The front longitudinal members 23 and the front cross members 24 are each provided with a closed cross section structure. The front edge (front end) of the front cross member 24 is formed linearly in the lateral direction. The front edge of the front cross member 24 is formed linearly in the lateral direction. The rear edge of the front cross member 24 is inclined rearward toward the left and right ends thereof. Thus, the fore and aft width of the front cross member 24 progressively increases toward the left and right ends thereof.

Behind the front cross member 24, a brace 26 extends laterally between the left and right front longitudinal members 23. The brace 26 has an X shape in plan view, and extends from the center to the front left, the front right, the rear left, and the rear right directions. The left and right ends in the front part of the brace 26 are joined to the left and right ends of the front cross member 24, respectively, and the left and right ends in the rear part of the brace 26 are joined to the left and right front longitudinal members 23, respectively. The brace 26 may be made of sheet steel having a vertically facing major plane.

As shown in FIG. 4, the front ends of the front longitudinal members 23 are positioned in an inwardly and downwardly offset relationship to the corresponding front side frame front portions 4A. More specifically, in plan view, a laterally outer part of the front end of each front longitudinal member 23 is positioned so as to overlap with a laterally inner part of the front end of the corresponding front side frame front portion 4A. Each front longitudinal member 23 is provided with a front end mounting portion 23A attached to the corresponding front side frame 4 at the front end thereof. The front end mounting portion 23A is provided on a laterally outer part of the front end of the front longitudinal member 23. The front end mounting portion 23A of each front longitudinal member 23 and the front end of the corresponding front side frame front portion 4A are connected to each other by a vertically extending front connecting member 28. More specifically, each front longitudinal member 23 is fastened to the lower end of the front connecting member 28 by a bolt inserted from below. Each front connecting member 28 forms a front end supporting portion that supports the front end of the corresponding front subframe 6. In the present embodiment, the front end mounting portion 23A is indirectly attached to the front side frame front portion 4A via the front connecting member 28. In another embodiment, the front end attachment portion 23A is indirectly attached to the front side frame front portion 4A via the front connection member 28.

The rear end of each front longitudinal member 23 is positioned under the corresponding lateral extension 4D. Therefore, the rear end of each front longitudinal member 23 is positioned laterally inward of the corresponding front side frame intermediate portion 4B. As shown in FIG. 7, the rear end of each front longitudinal member 23 is provided with a vertically extending collar 29A, and is fastened to the lower surface of the lateral extension 4D by a bolt 29B that is passed through the collar 29A from below and threaded into a nut 29C attached to the lateral extension 4D. The rear end of the front longitudinal member 23 projects rearward further than the horizontal extension 4D, and defines a laterally extending rear edge. In addition, the rear end of the front longitudinal member 23 progressively decreases in the vertical width (vertical thickness) toward the rear.

The rear end of each front longitudinal member 23 opposes the inclined surface 19A of the corresponding guide member 19 with a gap defined in the fore and aft direction. Further, in plan view, the rear end of each front longitudinal member 23 overlaps with the inclined surface 19A of the corresponding guide member 19.

As shown in FIG. 4, the lower surface of the rear end of each front longitudinal member 23 is connected to the lower surface of the corresponding front side frame intermediate portion 4B via a plate-like connecting member 27. The connecting member 27 is configured to be deformed, and to release the connection between the front longitudinal member 23 and the front side frame intermediate portion 4B when a predetermined load is applied thereto.

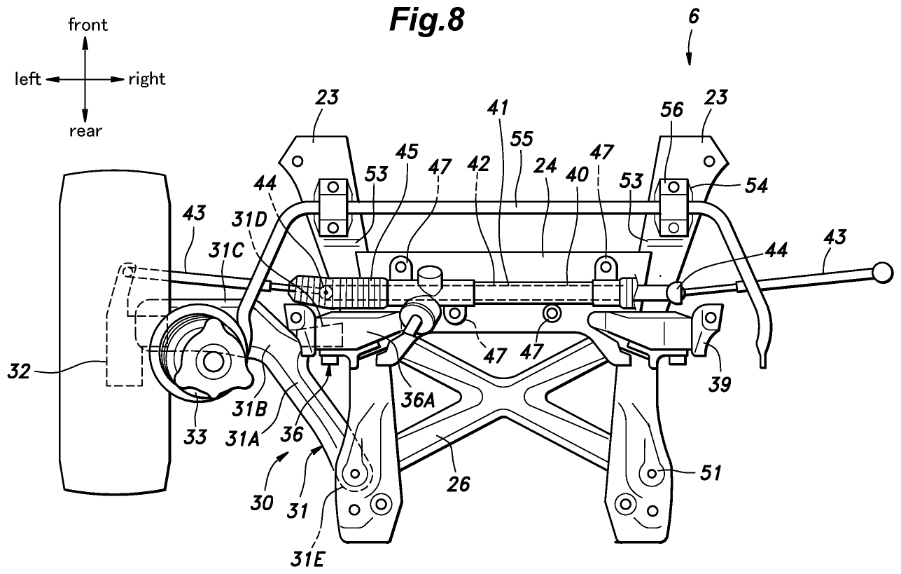

As shown in FIGS. 1 and 8, a pair of front suspension devices 30 are provided on the front subframe 6 and the corresponding front side frames 4. Each front suspension device 30 includes a lower arm 31 pivotally supported by the corresponding front longitudinal member 23, a front knuckle 32 supported by the lower arm 31, and a front shock absorber 33 connected between an upper part of the front knuckle 32 and the upper wall portion 17B of the corresponding front damper housing 17.

Each lower arm 31 consists of what is generally referred to as A-arm, and includes an arm rear portion 31A that extends obliquely forward and laterally outward from the rear end thereof, an arm curved portion 31B that extends laterally outward along a curve, and an arm front portion 31C extending laterally outward from the laterally outer end of the arm curved portion 31B and supporting the front knuckle 32 at the free end thereof. The arm front portion 31C is greater in horizontal width than the arm rear portion 31A and the arm curved portion 31B. A front pivotal support portion 31D protruded laterally inward from the laterally inner side of the arm curved portion 31B. The rotational center line of the front pivotal support portion 31D extends in the fore and aft direction. A rear pivotal support portion 31E having a vertically extending rotational center line is provided at the rear end of the arm rear portion 31A.

As shown in FIG. 4, each front longitudinal member 23 is provided with a front lower arm support portion 36 that supports the front pivotal support portion 31D of the corresponding lower arm 31, and a rear lower arm support portion 51 that supports the rear pivotal support portion 31E of the corresponding lower arm 31.

Each front lower arm support portion 36 laterally overlaps with the front cross member 24, and is connected to the corresponding front longitudinal member 23 and the front cross member 24.

As shown in FIG. 5, each front lower arm support portion 36 includes a base portion 36A that extends laterally above the corresponding front longitudinal member 23 to be connected to the front longitudinal member 23 and the front cross member 24, and a front support wall 36B and a rear support wall 36C that are connected to the base portion 36A and the corresponding front longitudinal member 23, and project laterally outward from the laterally outer side of the front longitudinal member 23.

The base portion 36A is formed as a hollow structure by combining a front member and a rear member with each other, and is connected to the upper surface and the laterally inner surface of the corresponding front longitudinal member 23 and the upper wall of the front cross member 24. The laterally inner end of the base portion 36A extends into the front cross member 24 through the upper wall of the front cross member 24 that is formed as a hollow structure. The base portion 36A extends upward and laterally outward from the upper surface of the front longitudinal member 23 to define the laterally outer end thereof. The laterally outer ends of the front longitudinal members 23 are located more laterally outward than the laterally outer sides of the respective front longitudinal members 23.

The laterally outer end of each base portion 36A is connected to the lower surface of the corresponding front side frame front portion 4A via a bracket 39. The bracket 39 includes an upper plate portion fastened to the lower surface of the front side frame front portion 4A by a vertically extending bolt, and a vertical plate portion depending from the laterally inner end of the upper plate portion. The vertical plate portion of the bracket 39 is in contact with the laterally outwardly facing end surface of the laterally outer end of the corresponding base portion 36A, and is fastened to the laterally outer end of the base portion 36A by laterally extending bolts.

The upper side of the base portion 36A includes an oblique portion 36D progressing rising upward from the laterally inner end to the laterally outer end. In other words, the oblique portion 36D extends obliquely from the front cross member 24 to the front side frame front portion 4A.

The front support wall 36B and the rear support wall 36C on each side of the vehicle body are plate-shaped members each having a major plane facing in the fore and aft direction, and are welded to the laterally outer side of the corresponding front longitudinal member 23 at the laterally inner edges thereof. The rear support wall 36C is positioned behind the front support wall 36B with a gap. The upper part of the laterally inner edge of the front support wall 36B extends upward beyond the upper end of the front longitudinal member 23, and is welded to the front surface of the base portion 36A. The upper part of the laterally inner edge of the rear support wall 36C extends upward beyond the upper end of the front longitudinal member 23, and is welded to the rear surface of the base portion 36A. The lower parts of the laterally inner edges of the front support wall 36B and the rear support wall 36C extend downward beyond the lower end of the front longitudinal member 23, and are welded to the lower surface of the front longitudinal member 23.

As shown in FIG. 8, the front pivotal support portion 31D of the lower arm 31 is positioned between the front support wall 36B and the rear support wall 36C. A rubber bush (not shown in the drawings) is fitted to the front pivotal support portion 31D of the lower arm 31, and a support shaft (not shown in the drawings) extending through the rubber bush is provided on the front support wall 36B and the rear support wall 36C.

As described above, the front lower arm support portion 36 has the base portion 36A, the front support wall 36B, and the rear support wall 36C, and pivotably supports the front pivotal support portion 31D of the lower arm 31. The front lower arm support portion 36 is welded to the front longitudinal member 23 and the front cross member 24, and is fastened to the front side frame front portion 4A via the bracket 39.

Preferably, as shown in FIG. 4, in plan view, the front support wall 36B forming the front end of the front lower arm support portion 36 is positioned ahead of the rear end of the laterally outer end of the front cross member 24, and the rear support wall 36C forming the rear end of the front lower arm support portion 36 is positioned behind the front end of the front cross member 24. In other words, it is preferable that the front lower arm support portion 36 overlaps with the front cross member 24 in the lateral direction. In the present embodiment, the front support wall 36B (the front end of the front lower arm support portion 36) is positioned behind the front end of the front cross member 24, and the rear support wall 36C (the rear end of the front lower arm support portion 36) is positioned ahead of the rear end of the front cross member 24.

As shown in FIG. 8, a steering gear box 40 is provided on the upper surface of the front cross member 24. The steering gear box 40 is provided with a cylindrical rack housing 41 extending laterally. A rack shaft 42 is provided inside the rack housing 41 so as to be slidable in the lateral direction with respect to the rack housing 41. The laterally outer ends of the rack shaft 42 project laterally outward from the left and right ends of the rack housing 41, respectively, and are connected to the left and right front knuckles 32 via tie rods 43, respectively. The rack shaft 42 and the tie rod 43 are connected by a joint 44 consisting of a ball joint, for example. Each joint 44 is enclosed in a boot 45 attached to the corresponding lateral end of the rack housing 41.

Four locations including two lateral end parts of the front part of the front cross member 24, and two parts of the front cross member 24 located behind these lateral end parts, and slightly laterally inward of the lateral inner end parts of the base portions 36A of the front lower arm support portions 36 are each provided with a collar which is passed vertically through the front cross member 24 and welded to the upper wall and the lower wall of the front cross member 24. The two rear collars 47 are arranged laterally inward of the two front collars 47.

The lateral end parts of the front side of the rack housing 41 are fastened to the left and right collars 47 provided on the front part of the front cross member 24 by bolts. The rear side of the rack housing 41 is fastened to one of two rear collars 47 provided on the front cross member 24 by a bolt. The shape of the rack housing 41 varies depending on if the steering shaft is provided on the left hand side or on the right hand side of the vehicle. The rear collar 47 to which the rack housing 41 is fastened is selected according to the shape of the rack housing 41. Thus, the rack housing 41 is fastened to the front cross member 24 at three locations.

The front edge (front end) of each front lower arm support portion 36 is positioned more rearward than the front edge (front end) of the front cross member 24. The laterally inner end portion of the slanted portion 36D of each base portion 36A is positioned laterally outward of (to the side of) the upper end of the corresponding rear-side collar 47.

Each rear lower arm support portion 51 is provided in a part of the corresponding front longitudinal member 23 located between the front lower arm support portion 36 and the rear end of the front longitudinal member 23 fastened to the lateral extension 4D. The rear lower arm support portion 51 has an opening 51A formed in a laterally outer face of the front longitudinal member 23 and a support shaft (not shown in the drawings) provided in a deeper side of the opening 51A and extending vertically to be joined to the upper and lower walls of the front longitudinal member 23. The rear pivotal support portion 31E of each lower arm 31 is fitted with a rubber bushing (not shown in the drawings) through which the support shaft is passed. The rear pivotal support portion 31E of the lower arm 31 is allowed to move relative to the rear lower arm support portion 51 by the deformation of the rubber bushing. Thereby, each lower arm 31 is pivotably supported to the front subframe 6 by the front lower arm support portion 36 and the rear lower arm support portion 51.

As shown in FIG. 4, in bottom view (or in plan view), the rear lower arm support portion 51 on the left side is positioned on an extension line obtained by extending the left rear end portion of the brace 26. Also, in plan view, the rear lower arm support portion 51 on the right side is positioned on an extension line obtained by extending the right rear end portion of the brace 26. The rear lower arm supports 51 are positioned more laterally inward than the respective front lower arm support portions 36. Further, the rear lower arm support portions 51 are also positioned more laterally inward than the left and right joints 44, respectively.

Each front lower arm support portion 36 is positioned more rearward than the steering gearbox 40. Each arm front part 31C may extend slightly obliquely rearward toward the laterally outward direction, and the joint 44 on the same lateral side may be provided such that the joint 44 is positioned on an extension line obtained by extrapolating the arm front part 31C in the lengthwise direction when the steering is neutral.

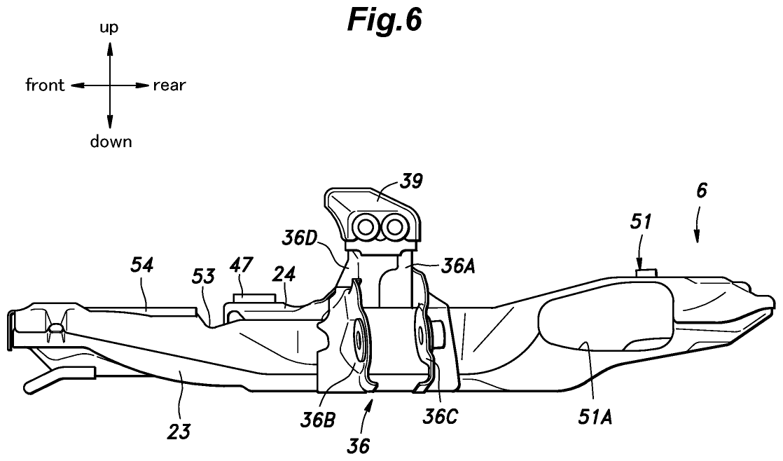

As shown in FIGS. 5 and 6, each front longitudinal member 23 is provided, in a part thereof forward of the joint with the front cross member 24, with a deformation promoting portion 53 which has a lower stiffness than the other part of the front longitudinal member 23. The deformation promoting portion 53 is a recess that is formed in the upper surface of the front longitudinal members 23 to be recessed downward. The deformation promoting portion 53 extends laterally from the laterally inner surface to the laterally outer face of the front longitudinal member 23. When a collision load is applied to the front longitudinal member 23 in the fore-and-aft direction, a deformation of the front longitudinal member 23 occurs first at the deformation promoting portion 53, and the front longitudinal member 23 is bent downward at the deformation promoting portion 53.

A reinforcing plate 54 extends along and is attached to a part of the upper surface of each front longitudinal member 23 located forward of the deformation promoting portion 53. A front stabilizer support portion 56 for rotatably supporting a front stabilizer 55 is provided on each reinforcing plate 54. The front stabilizer 55 is a rod member including a laterally extending portion and left and right end portions that extend rearward from the left and right ends of the laterally extending portion, respectively. The left and right end portions of the front stabilizer 55 are joined to the lower ends of the left and right front shock absorbers 33, respectively, via respective connecting members. Each front stabilizer support portion 56 is formed with a support hole (not shown in the drawings) through which the laterally extending portion of the front stabilizer 55 is passed. A rubber bushing for supporting the laterally extending portion of the front stabilizer 55 is fitted in the support hole of each front stabilizer support portion 56. Each front stabilizer support portion 56 is fastened to the upper surface of the corresponding front longitudinal member 23 by means of multiple bolts. A part of each front longitudinal member 23 on which the reinforcing plate 54 and the front stabilizer support portion 56 are provided is given a higher stiffness than the other part of the same.

As shown in FIGS. 1 and 2, the vehicle body structure 1 includes, as a rear structure, a pair of left and right rear side frames 71 respectively extending rearward from the rear ends of the left and right side sills 3 and a rear subframe 72 provided on the underside the rear side frames 71. The rear subframe 72 supports rear wheels 74 via rear suspension devices 73, and also supports an electric motor 75 serving as a drive source for driving the rear wheels 74. In another embodiment, the driving source is an internal combustion engine.

As shown in FIG. 2, each rear side frame 71 includes a rear side frame front part 71A (kick-up part) extending from the rear end of the corresponding side sill 3 upward and laterally inward toward the rear in an oblique manner, and a rear side frame rear part 71C extending rearward from the rear end of the rear side frame front part 71A via a rear side frame bent part 71B. Each rear side frame 71 has a lower wall, an inner sidewall located on the laterally inner side, an outer sidewall located on the laterally outer side, and an upper wall, whereby the rear side frame 71 has a rectangular closed cross-section.

The left and right rear side frame front parts 71A are joined to each other by a vehicle body cross member 77 that extends laterally. The left and right end portions of the vehicle body cross member 77 are joined to laterally inner surfaces of front parts of the rear side frame front parts 71A, respectively. A rear floor panel 78 is provided on the upper side of the left and right rear side frames 71 and the vehicle body cross member 77. The vehicle body cross member 77 has a hat-shaped cross-section opening upward and forms a closed section structure in cooperation with the rear floor panel 78. A pair of left and right floor members 79A are joined to a laterally middle portion of the vehicle body cross member 77 so as to extend forward along the lower surface of the rear floor panel 78. The floor members 79 are formed to have a lower height than the vehicle body cross member 77.

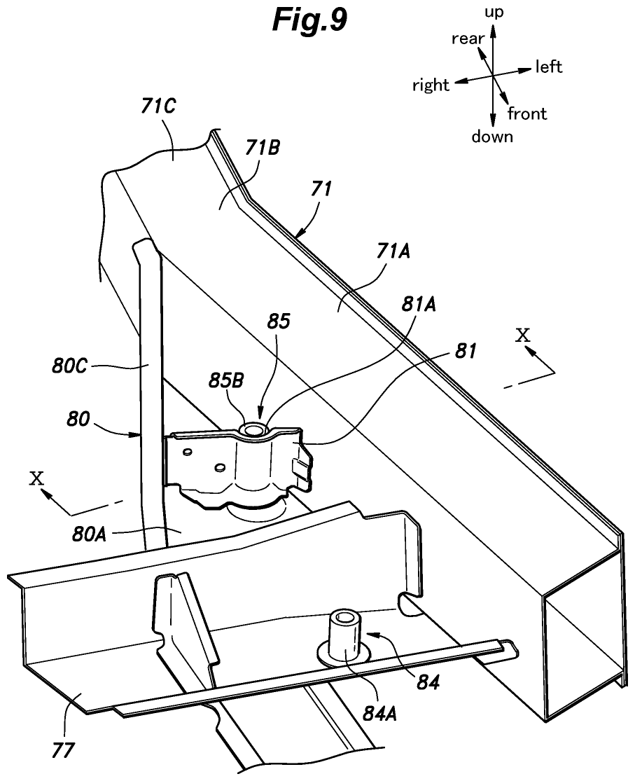

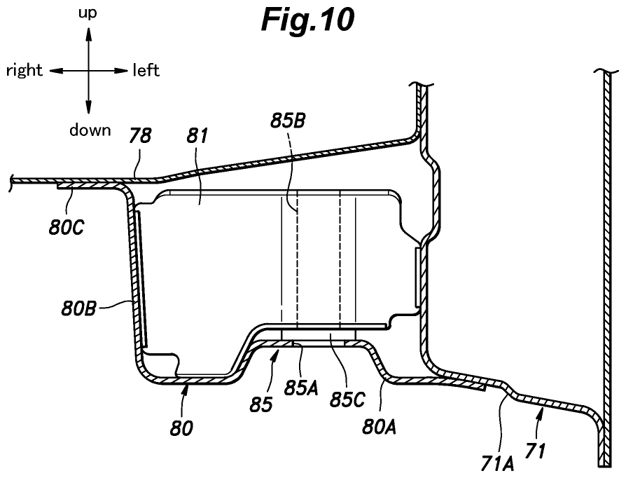

As shown in FIGS. 2 and 9, a pair of left and right load transmitting members 80 are provided on the rear side of the vehicle body cross member 77 and on the laterally inner side of the left and right rear side frame front parts 71A, respectively. Each load transmitting member 80 is provided in the corner formed by the corresponding rear side frame front part 71A and the vehicle body cross member 77. As shown in FIGS. 9 and 10, each load transmitting member 80 includes a bottom wall 80A having a vertically facing surface, a vertical wall 80B extending upward from a laterally inner edge of the bottom wall 80A, and a flange 80C extending laterally inward from an upper edge of the vertical wall 80B.

The bottom wall 80A has a laterally extending front edge and inner and outer edges that extend obliquely rearward from lateral ends of the front edge, respectively, so as to approach each other toward the rear, whereby the bottom wall 80A is formed in a triangle. Namely, the bottom wall 80A of each load transmitting member 80 has a lateral width that increases gradually toward the front. More specifically, the bottom wall 80A is formed in an isosceles triangle, with the inner edge and the outer edge having a substantially same length. The front edge of the bottom wall 80A extends along the lower surface of the vehicle body cross member 77 and is welded to the lower surface of the vehicle body cross member 77 at multiple positions. The outer edge of the bottom wall 80A extends along the lower surface of the lower wall of the rear side frame front part 71A and is welded to the lower wall of the rear side frame front part 71A at multiple positions. The flange 80C is welded to the lower surface of the rear floor panel 78 at multiple positions. The vertical wall 80B and the flange 80C extend from the rear end of the rear side frame front part 71A forward and laterally inward to the rear face of the vehicle body cross member 77. Each load transmitting member 80 forms a closed section structure in cooperation with the rear side frame front part 71A, the vehicle body cross member 77, and the rear floor panel 78.

In the closed section structure formed by the load transmitting member 80, the rear side frame front part 71A, the vehicle body cross member 77, and the rear floor panel 78, at least one partition wall 81 is provided. In the illustrated embodiment, a single partition wall 81 is provided. The partition wall 81 has a surface facing in the fore-and-aft direction, extends laterally, and has a laterally inner end welded to the vertical wall 80B of the load transmitting member 80 and a laterally outer end welded to the inner sidewall of the rear side frame front part 71A. Further, the partition wall 81 has a lower end welded to the bottom wall 80A of the load transmitting member 80. The laterally inner end, the laterally outer end, and the lower end of the partition wall 81 are preferably bent to form flanges. In another embodiment, the upper end of the partition wall 81 may be welded to the lower surface of the rear floor panel 78.

As shown in FIG. 2, the rear part of the vehicle body structure 1 is provided, on each lateral side thereof, with first to fourth vehicle body-side attachment portions 83 to 86 for attachment of the rear subframe 72. Each of the left and right first vehicle body-side attachment portions 83 is provided in a front end portion of the corresponding rear side frame front part 71A. Each first vehicle body-side attachment portion 83 is constituted of a through-hole formed in the lower wall of the rear side frame front part 71A and a collar (not shown in the drawings) provided on the upper surface side of the lower wall of the rear side frame front part 71A so as to oppose the through-hole. The collar extends vertically inside the rear side frame front part 71A and is welded to the lower wall of the rear side frame front part 71A. Preferably, the collar may also be welded to a partition wall (not shown in the drawings) provided inside the rear side frame front part 71A. The collar is formed with a female thread in an inner periphery thereof.

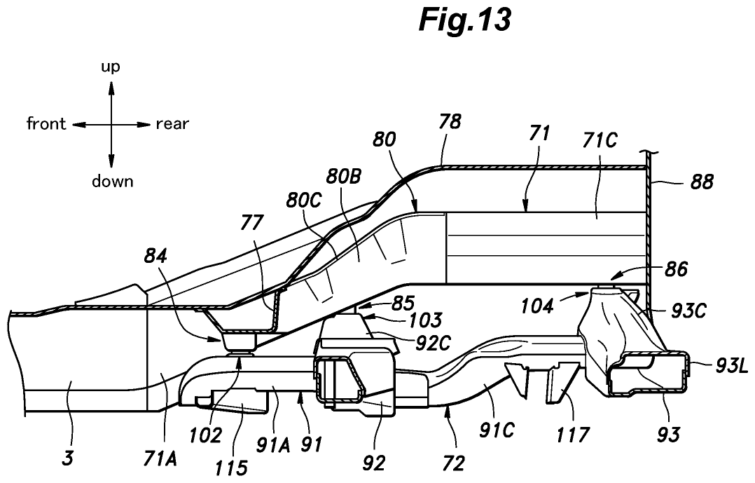

As shown in FIGS. 2, 9, and 13, the left and right second vehicle body-side attachment portions 84 are respectively provided on the left and right end portions of the vehicle body cross member 77. The second vehicle body-side attachment portions 84 are positioned more laterally inward than the first vehicle body-side attachment portions 83. Each second vehicle body-side attachment portion 84 is constituted of a through-hole formed in the lower wall of the vehicle body cross member 77 and a collar 84A provided on the upper surface side of the lower wall of the vehicle body cross member 77 so as to oppose the through-hole. The collar 84A extends vertically inside the vehicle body cross member 77 and is welded to the lower wall of the vehicle body cross member 77. Preferably, the collar 84A may also be welded to a partition wall (not shown in the drawings) provided inside the vehicle body cross member 77. The collar 84A is formed with a female thread in an inner periphery thereof.

As shown in FIGS. 9 and 10, each of the left and right third vehicle body-side attachment portions 85 is provided on the corresponding load transmitting member 80. The left and right third vehicle body-side attachment portions 85 are arranged at substantially the same lateral positions as the left and right second vehicle body-side attachment portions 84, respectively. Each third vehicle body-side attachment portion 85 is constituted of a through-hole 85A extending vertically through the bottom wall 80A of the corresponding load transmitting member 80 and a collar 85B provided on the upper surface of the bottom wall 80A so as to oppose the through-hole 85A. The collar 85B extends vertically, has a lower end welded to the upper surface of the bottom wall 80A, and has a side surface welded to the partition wall 81. The partition wall 81 is formed with a recess 81A for receiving a side part of the collar 85B. Further, the collar 85B has a flange 85C in the lower end thereof and is in contact with the bottom wall 80A at the flange 85C. The collar 85B is formed with a female thread in an inner periphery thereof.

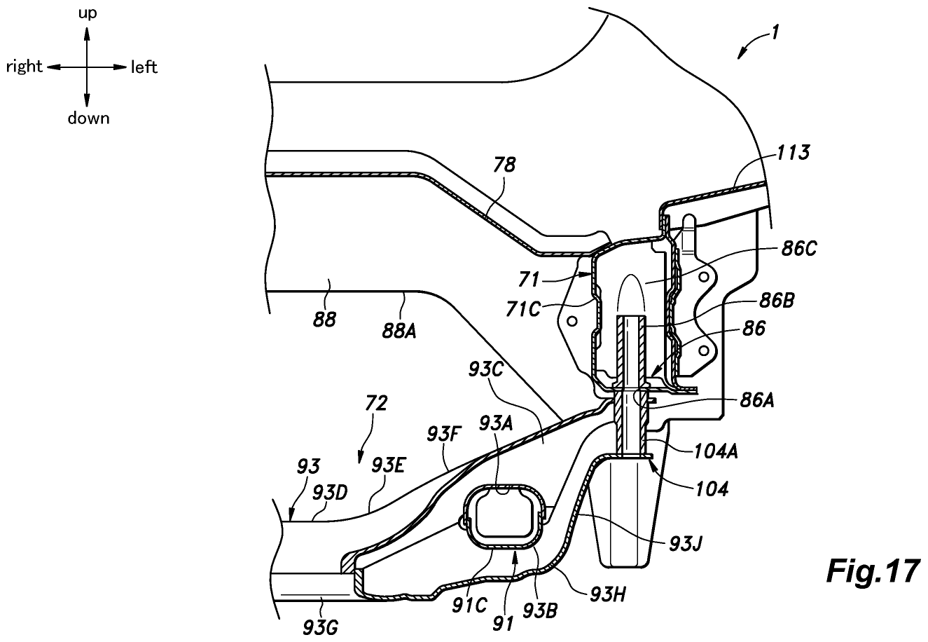

As shown in FIGS. 2 and 17, each of the left and right fourth vehicle body-side attachment portions 86 is provided in the rear end of the corresponding rear side frame rear part 71C. Each fourth vehicle body-side attachment portion 86 is constituted of a through-hole 86A formed in the lower wall of the corresponding rear side frame rear part 71C and a collar 86B provided on the upper surface side of the lower wall of the rear side frame rear part 71C so as to oppose the through-hole 86A. The collar 86B extends vertically inside the rear side frame rear part 71C and is welded to the lower wall of the rear side frame rear part 71C. Further, the collar 86B is welded to a partition wall 86C provided inside the rear side frame rear part 71C. The collar 86B is formed with a female thread in an inner periphery thereof.

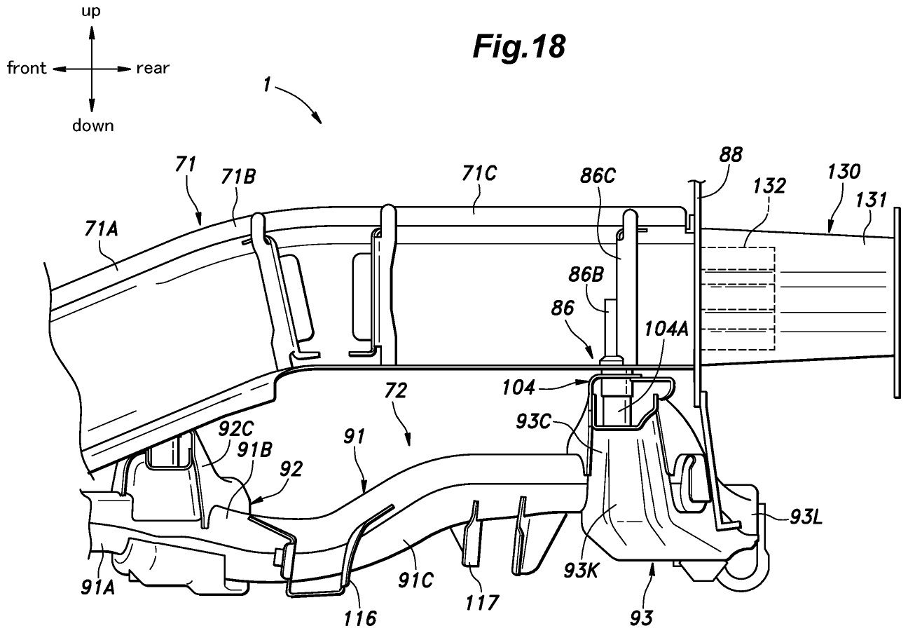

As shown in FIGS. 17 and 18, the rear ends of the left and right rear side frame rear parts 71C are joined to a rear panel 88 that extends laterally to have a surface facing in the fore-and-aft direction. The rear panel 88 is joined to the rear edge of the rear floor panel 78.

The rear subframe 72 includes a pair of left and right rear longitudinal members 91 extending in the fore-and-aft direction, and a first rear cross member 92 and a second rear cross member 93 each extending laterally and joined to the rear longitudinal members 91. The first rear cross member 92 is positioned forward of the second rear cross member 93.

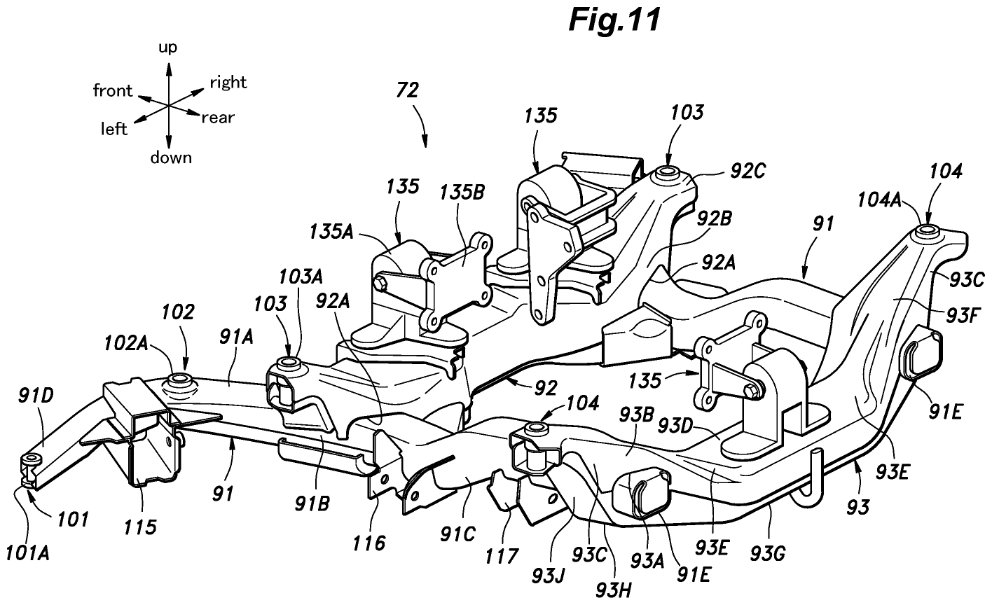

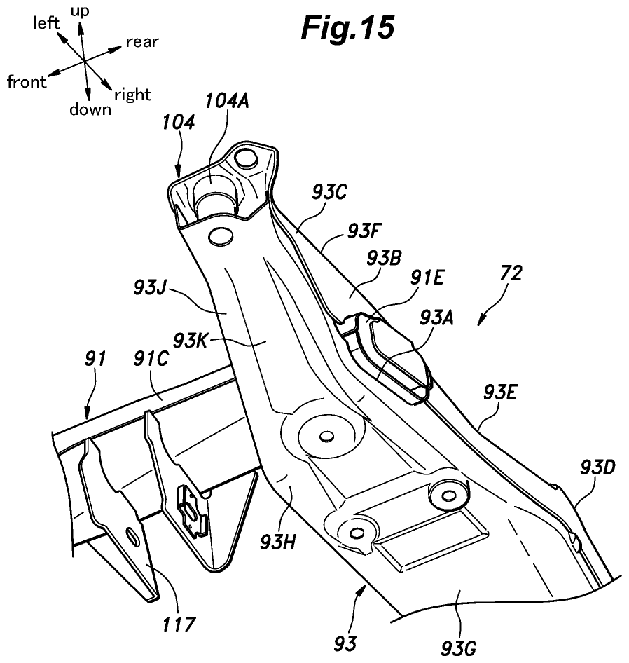

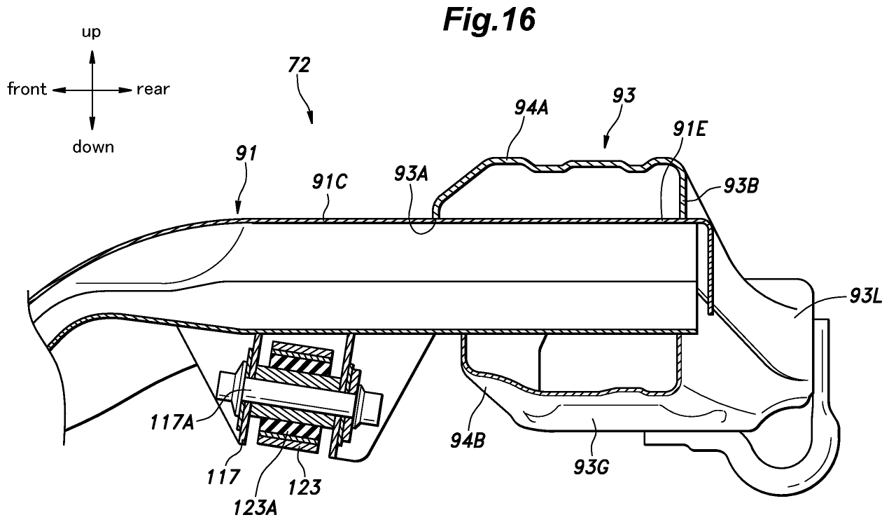

Each of the left and right rear longitudinal members 91, the first rear cross member 92, and the second rear cross member 93 is formed by combining an upper member (e.g., an upper member 94A constituting the second rear cross member 93) having a channel-shaped cross-section that opens downward and a lower member (e.g., a lower member 94B constituting the second rear cross member 93) having a channel-shaped cross-section that opens upward, and has a hollow structure (see FIG. 16). Preferably, the upper member and the lower member include sidewalls having free ends overlapping each other, and are welded to each other at the overlapping free ends (see FIG. 15). As shown in FIG. 11, the first rear cross member 92 has a pair of left and right first longitudinal member insertion holes 92A extending therethrough in the fore-and-aft direction. The second rear cross member 93 has a pair of left and right second longitudinal member insertion holes 93A extending therethrough in the fore-and-aft direction. Each of the left and right rear longitudinal members 91 extends in the fore-and-aft direction to pass through the corresponding first longitudinal member insertion hole 92A and the corresponding second longitudinal member insertion holes 93A and is welded to the first rear cross member 92 and the second rear cross member 93 in the first longitudinal member insertion hole 92A and the second longitudinal member insertion hole 93A. The parts of the first rear cross member 92 joined to the left and right rear longitudinal members 91, namely, the parts around the first longitudinal member insertion holes 92A are referred to as first longitudinal member joint portions 92B. Also, the parts of the second rear cross member 93 joined to the left and right rear longitudinal members 91, namely, the parts around the second longitudinal member insertion holes 93A are referred to as second longitudinal member joint portions 93B.

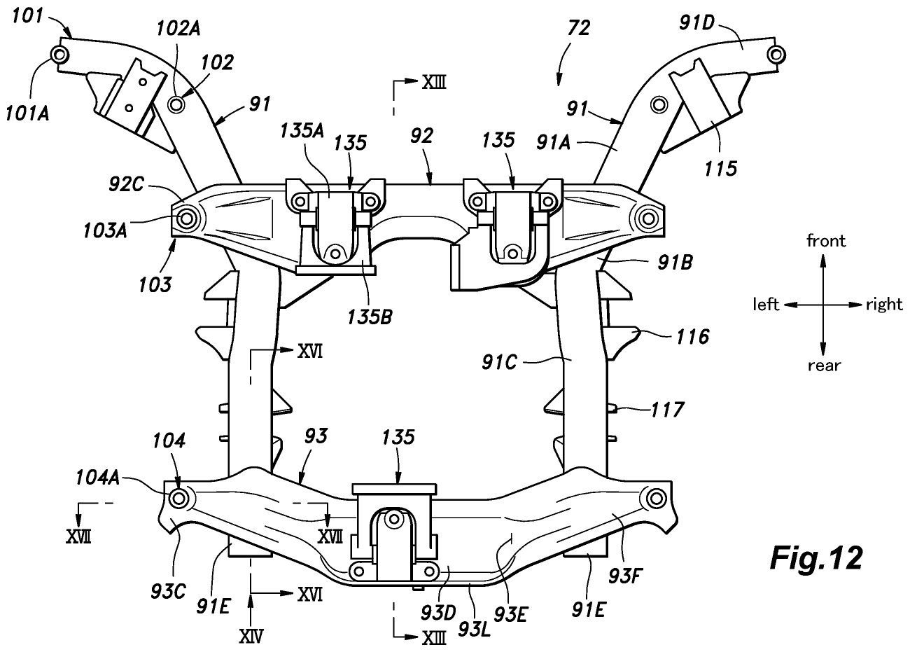

As shown in FIGS. 11 and 12, each rear longitudinal member 91 includes a rear longitudinal member front part 91A extending rearward and laterally inward in an oblique manner and a rear longitudinal member rear part 91C extending rearward from the rear end of the rear longitudinal member front part 91A via a rear longitudinal member bent part 91B. The rear longitudinal member bent part 91B of each rear longitudinal member 91 is joined to the corresponding first longitudinal member joint portion 92B of the first rear cross member 92. The rear longitudinal member rear part 91C extends from the first longitudinal member joint portion 92B of the first rear cross member 92 to the second longitudinal member joint portion 93B of the second rear cross member 93. At the front end of each rear longitudinal member front part 91A, a rear longitudinal member front end part 91D is provided which extends laterally outward.

A first rear subframe-side attachment portion 101 is formed in the laterally outer end of each rear longitudinal member front end part 91D. The first rear subframe-side attachment portion 101 includes a collar 101A extending vertically through the rear longitudinal member front end part 91D. The collar 101A is welded to the upper and lower walls of the rear longitudinal member front end part 91D. Each first rear subframe-side attachment portion 101 is disposed on the underside of the corresponding first vehicle body-side attachment portion 83 and is fastened to the first vehicle body-side attachment portion 83 by a bolt.

Each rear longitudinal member front part 91A is formed with a second rear subframe-side attachment portion 102. The second rear subframe-side attachment portion 102 includes a collar 102A extending vertically through the rear longitudinal member front part 91A. The collar 102A is welded to the upper and lower walls of the rear longitudinal member front part 91A. Each second rear subframe-side attachment portion 102 is disposed on the underside of the corresponding second vehicle body-side attachment portion 84 and is fastened to the second vehicle body-side attachment portion 84 by a bolt.

Each of the left and right end portions of the first rear cross member 92 is provided with a first extension 92C that extends laterally outward and upward from the corresponding first longitudinal member joint portion 92B (the corresponding rear longitudinal member 91). Each first extension 92C has a tip end (laterally outer end) formed with a third rear subframe-side attachment portion 103. The third rear subframe-side attachment portion 103 includes a collar 103A extending vertically through the tip end of the first extension 92C. The collar 103A is welded to the upper and lower walls of the first extension 92C. Each third rear subframe-side attachment portion 103 is disposed on the underside of the corresponding third vehicle body-side attachment portion 85 and is fastened to the third vehicle body-side attachment portion 85 by a bolt.

Each of the left and right end portions of the second rear cross member 93 is provided with a second extension 93C that extends laterally outward and upward from the corresponding second longitudinal member joint portion 93B (the corresponding rear longitudinal member 91). Each second extension 93C has a tip end (laterally outer end) formed with a fourth rear subframe-side attachment portion 104. The fourth rear subframe-side attachment portion 104 includes a collar 104A extending vertically through the tip end of the second extension 93C. The collar 104A is welded to the upper and lower walls of the second extension 93C. Each fourth rear subframe-side attachment portion 104 is disposed on the underside of the corresponding fourth vehicle body-side attachment portion 86 and is fastened to the fourth vehicle body-side attachment portions 86 by a bolt. Each of the rear longitudinal members 91 is provided, in the rear end portion thereof, with a rear-end attachment portion 91E attached to the corresponding rear side frame 71. The rear-end attachment portion 91E is attached to the rear side frame rear part 71C indirectly via the second extension 93C of the second rear cross member 93. In another embodiment, the rear-end attachment portion 91E may be attached to the rear side frame rear part 71C directly.

Each of the first extensions 92C and the second extensions 93C has a vertical width that decreases gradually toward the laterally outward direction. Namely, each of the first extensions 92C and the second extensions 93C becomes thinner toward the tip end.

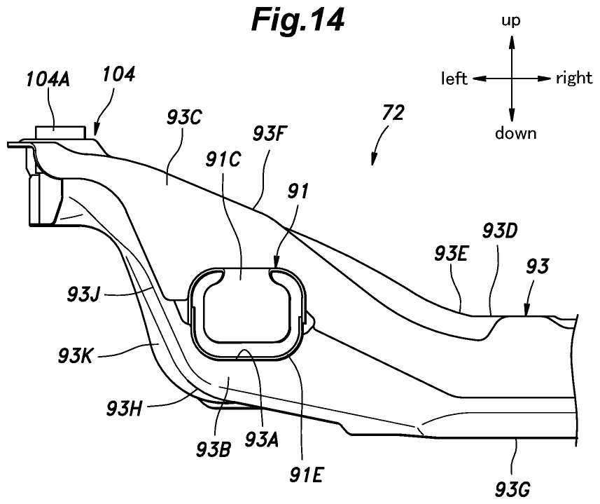

As shown in FIGS. 14 and 15, the second rear cross member 93 includes an upper surface central part 93D having an upward-facing surface and extending laterally, a pair of left and right upper surface slanted parts 93F extending laterally outward and upward from the left and right ends of the upper surface central part 93D, respectively, via upper surface bent parts 93E, a lower surface central part 93G having a downward-facing surface and extending laterally, and a pair of left and right lower surface slanted parts 93J extending laterally outward and upward from the left and right ends of the lower surface central part 93G, respectively, via lower surface bent parts 93H. The laterally outer ends of the upper surface slanted parts 93F and the lower surface slanted parts 93J reach the associated fourth rear subframe-side attachment portions 104. The upper surface central part 93D, the upper surface bent parts 93E, and the upper surface slanted parts 93F are formed in an upper member 94A constituting the second rear cross member 93, while the lower surface central part 93G, the lower surface bent parts 93H, and the lower surface slanted parts 93J are formed in a lower member 94B constituting the second rear cross member 93.

The left and right upper surface bent parts 93E are positioned laterally inward of the left and right second longitudinal member joint portions 93B, and the left and right lower surface bent parts 93H are positioned laterally outward of the left and right second longitudinal member joint portions 93B. Thereby, the second rear cross member 93 has the largest vertical width at each of the second longitudinal member joint portions 93B. The angle of each upper surface bent part 93E relative to the horizontal plane is smaller than the angle of each lower surface bent part 93H relative to the horizontal plane. Each of the lower surface slanted parts 93J includes a reinforcing bead 93K extending from the corresponding lower surface bent part 93H toward the corresponding fourth rear subframe-side attachment portion 104.

As shown in FIG. 1, the rear longitudinal members 91 are positioned laterally inward of and below the respective rear side frames 71. In plan view, each rear longitudinal member front part 91A and the corresponding rear side frame front part 71A are arranged in parallel to each other, and each rear longitudinal member rear part 91C and the corresponding rear side frame rear part 71C are arranged in parallel to each other. The rear side frame bent parts 71B are arranged at substantially the same fore-and-aft positions as the rear longitudinal member bent parts 91B.

Each of the rear side frames 71 is provided with a rear damper mount 112 for supporting an upper end of a corresponding rear shock absorber 111. The rear damper mount 112 may constitute a part of a side panel 113 forming a rear sidewall of the vehicle 2. Each rear side frame bent part 71B and each rear longitudinal member bent part 91B are arranged at positions overlapping (or generally aligned with) the corresponding rear damper mount 112 in the lateral direction. In other words, the rear side frame bent part 71B and the rear longitudinal member bent part 91B are positioned rearward of the front end of the rear damper mount 112 and forward of the rear end of the rear damper mount 112.

Each of the left and right rear longitudinal members 91 is provided with, from the front side, a first suspension arm support 115, a second suspension arm support 116, and a third suspension arm support 117. The first suspension arm support 115 is provided at the boundary between the rear longitudinal member front end part 91D and the rear longitudinal member front part 91A, the second suspension arm support 116 and the third suspension arm support 117 are provided on the rear longitudinal member rear part 91C. The first to third suspension arm supports 115-117 rotatably support inner ends of first to third suspension arms 121-123, respectively, via rubber bushings. Taking the third suspension arm 123 as an example, as shown in FIG. 16, a rubber bushing 123A is provided in the inner end of the third suspension arm 123, and the rubber bushing 123A is supported by a support shaft 117A provided in the third suspension arm support 117. A rear knuckle 124 for rotatably supporting the corresponding rear wheel 74 is supported at the outer ends of the first to third suspension arms 121-123. An upper part of the rear knuckle 124 is connected to the rear damper mount 112 via the rear shock absorber 111.

As shown in FIG. 1, the lower parts of the left and right rear shock absorbers 111 are connected to each other by a rear stabilizer 126. The rear stabilizer 126 is a rod member and includes a laterally extending portion and left and right end portions that extend rearward from the left and right ends of the laterally extending portion, respectively. The left and right end portions of the rear stabilizer 126 are joined to the lower ends of the left and right rear shock absorbers 111 via connecting members, respectively. The lower surfaces of the left and right rear longitudinal member front parts 91A are each provided with s rear stabilizer support 127 for rotatably supporting the laterally extending portion of the rear stabilizer 126.

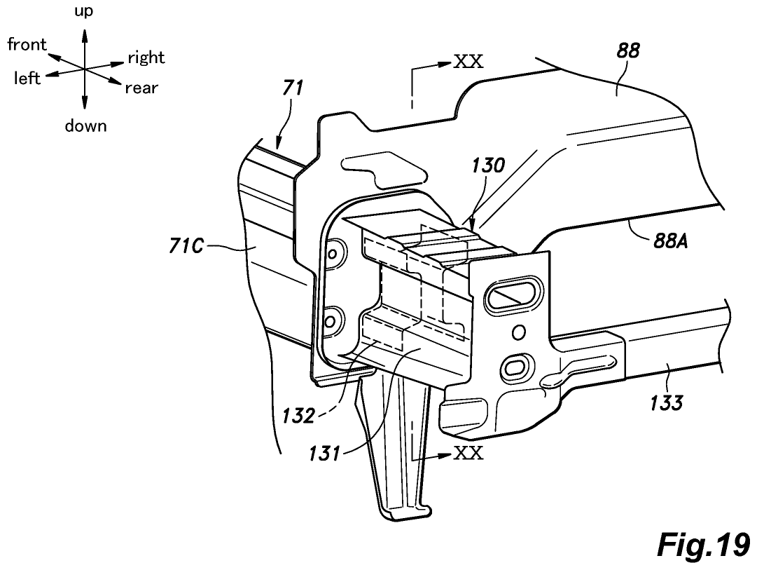

As shown in FIGS. 18 and 19, a pair of left and right shock-absorbing structures 130 that extend rearward are provided at the rear ends of the left and right rear side frames 71, respectively, via the rear panel 88. Each shock-absorbing structure 130 includes a first shock-absorbing member 131 and a second shock-absorbing member 132 each extending rearward from the rear face of the rear panel 88. The second shock-absorbing member 132 has higher fore-and-aft strength (stiffness) than the first shock-absorbing member 131. The second shock-absorbing member 132 has a shorter fore-and-aft dimension than the first shock-absorbing member 131, and the rear end of the second shock-absorbing member 132 is positioned forward of the rear end of the first shock-absorbing member 131.

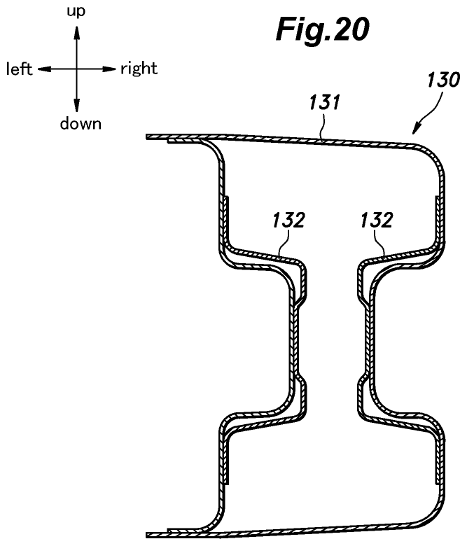

As shown in FIGS. 19 and 20, the first shock-absorbing member 131 is a crash box constituted of two steel sheets formed in a tubular shape having an axis extending in the fore-and-aft direction. The first shock-absorbing member 131 is formed such that the lateral width at a vertically middle part thereof is smaller than each of the lateral width at an upper part thereof and the lateral width at a lower part thereof. Preferably, the first shock-absorbing member 131 is formed with multiple grooves and ridges extending laterally or vertically. The rear ends of the left and right first shock-absorbing members 131 are joined to a rear bumper beam 133 that extends laterally.

Each second shock-absorbing member 132 is positioned inside the corresponding first shock-absorbing member 131 formed in a tubular shape. In the present embodiment, each second shock-absorbing member 132 is constituted of two steel sheets welded to the inner surfaces of left and right parts of the corresponding first shock-absorbing member 131. The two sheets constituting each second shock-absorbing member 132 are each bent to have recesses and ridges to define closed section structures in cooperation with the associated first shock-absorbing member 131. Preferably, the second shock-absorbing members 132 are made of a material having a higher strength (stiffness) than the first shock-absorbing members 131.

As shown in FIGS. 12 and 18, the second rear cross member 93 includes a protrusion 93L that protrudes rearward in a laterally central part thereof. A central part of the lower edge of the rear panel 88 is formed with a cutout (notch) 88A that is recessed upward (see FIGS. 17 and 19), and the protrusion 93L protrudes through the cutout 88A to the rear of the rear panel 88. The rear end of the protrusion 93L is positioned more rearward than the rear ends of the rear side frames 71 and the rear panel 88 and more forward than the rear ends of the shock-absorbing structures 130. More specifically, the rear end of the protrusion 93L is positioned more rearward than the rear ends of the second shock-absorbing members 132 and more forward than the rear ends of the first shock-absorbing members 131. The rear edge of the second rear cross member 93 extends from the protrusion 93L forward and laterally outward in an oblique manner toward each of the left and right fourth rear subframe-side attachment portions 104. In the illustrated embodiment, the second rear cross member 93 has a generally arcuate shape in plan view (bottom view) to be concave rearward, and the protrusion 93L is defined by the concave portion.

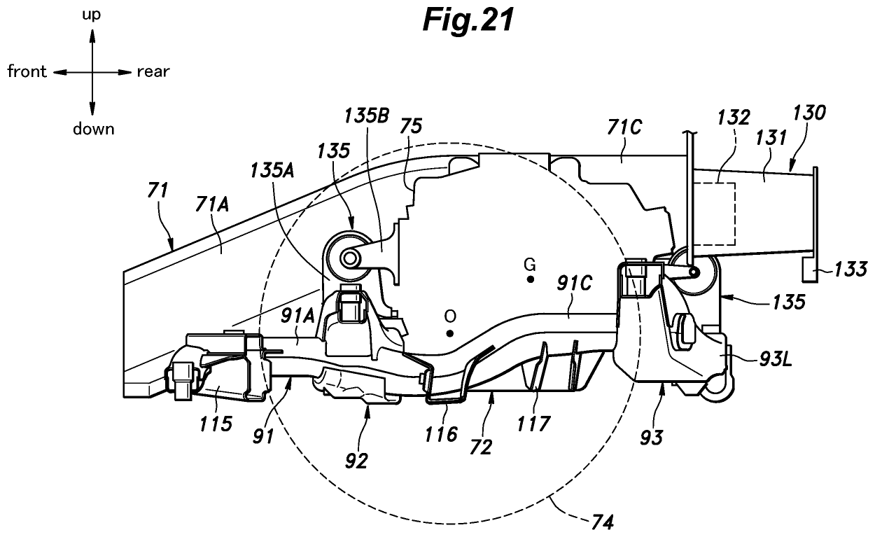

As shown in FIG. 21, an electric motor 75 serving as a driving source is mounted on an upper side of the rear subframe 72. The electric motor 75 is supported by two mounts 135 provided on the first rear cross member 92 and one mount 135 provided on the second rear cross member 93. Each mount 135 includes s base 135A fastened to the first or second rear cross member 92, 93 and supporting a rubber bushing, and an arm 135B supported by the base via the rubber bushing and fastened to the electric motor 75.

The electric motor 75 is supported on the rear subframe 72 such that the rotation axis thereof extends laterally. The driving force of the electric motor 75 is transmitted to the rear wheels 74 via a transmission mechanism. The electric motor 75 is arranged such that the center of gravity G thereof is positioned rearward of the rotation axis O of the rear wheels 74. Namely, the electric motor 75 is placed in a rear-end portion of the vehicle 2.

The rear end of the protrusion 93L is positioned rearward of the rear end of the electric motor 75. The upper ends of the shock-absorbing structures 130 (the first shock-absorbing members 131) are positioned higher than the lower end of the electric motor 75, and the lower ends of the shock-absorbing structures 130 (the first shock-absorbing members 131) are positioned lower than the upper end of the electric motor 75. In other words, as seen in the fore-and-aft direction, the shock-absorbing structures 130 are arranged at positions overlapping the electric motor 75. Owing to the above arrangement, the load at the time of a rear collision is not applied directly to the electric motor 75 but is applied the second rear cross member 93 and at least one of the shock-absorbing structures 130.

As shown in FIG. 1, a battery 140 is disposed on the underside of the front floor panel 7 and the rear floor panel 78. In plan view (bottom view), the battery 140 is positioned in a region surrounded by the left and right side sills 3, the front subframe 6, and the rear subframe 72. Also, it can be said that the battery 140 is positioned in a region surrounded by the left and right side sills 3, the left and right front side frame inclined parts 4C, the left and right lateral extensions 4D, and the vehicle body cross member 77.

The battery 140 includes multiple battery cells connected to each other and a battery case containing the multiple battery cells therein. The battery case, which serves as an outer shell of the battery 140, is supported by multiple battery support members 143 extending between the left and right side sills 3.

In the following, the effects and advantages of the aforementioned embodiment will be described. In the vehicle body structure 1 according to the embodiment, a load at the time of a frontal collision is transmitted to the left and right side sills 3 via the left and right front side frames 4, and the transmission thereof to the battery 140 is suppressed. In addition, the front subframe 6 attached to the front side frames 4 absorbs the frontal collision load, whereby the load transmission to the battery 140 can be suppressed. A load in a rear collision is transmitted to the left and right side sills 3 via the left and right rear side frames 71, and the transmission thereof to the battery 140 is suppressed. Also, the rear subframe 72 attached to the rear side frames 71 absorbs the rear collision load, whereby the load transmission to the battery 140 can be suppressed. Since the battery 140 is positioned in a relatively large region surrounded by the left and right side sills 3, the front subframe 6, and the rear subframe 72, the battery 140 may have a large size.

The front subframe 6, on which the electric motor 75 is not mounted, breaks away from the rear-end supports 21 and moves downward when applied with a collision load, whereby the load transmission from the front subframe 6 to the battery 140 can be suppressed. Each guide member 19 abuts the rear end of the front subframe 6 at the slanted surface 19A thereof and guides the front subframe 6 to move downward in a reliable manner.

The load transmitting members 80 causes the load applied to the rear side frames 71 from the rear at the time of a rear collision to be dispersed to the side sills 3 and the vehicle body cross member 77, such that the deformation of the rear side frames 71 can be suppressed. Thereby, the rear side frames 71 can resist to the load at the time of a rear collision, and the electric motor 75 mounted on the rear subframe 72 can be protected properly. Each load transmitting member 80 forms a closed section structure in cooperation with the corresponding rear side frame 71 and the rear floor panel 78 such that the stiffness of the load transmitting member 80 is improved. The stiffness of the load transmitting member 80 is also improved by the partition wall 81 and the collar 85B. Thus, the load transmitting members 80 are provided with relatively high stiffness, and the third vehicle body-side attachment portions 85 are provided in these load transmitting members 80, whereby the rear subframe 72 can be supported highly stably. Because each load transmitting member 80 has a lateral width that increases gradually toward the front, the load applied to the rear side frames 71 can be dispersed over a wide range of the vehicle body cross member 77 owing to the load transmitting members 80.

A lateral load input from the first to third suspension arms 121-123 to the rear longitudinal members 91 is transmitted to the load transmitting members 80 and the rear side frames 71 via the first and second longitudinal member joint portions 92B, 93B, the first and second extensions 92C, 93C, and the third and fourth rear subframe-side attachment portions 103, 104 in this order. Therefore, the stiffness of the rear subframe 72 against the lateral load input from the suspension arms can be improved.

Since the second rear cross member 93 has the largest vertical width at each of the second longitudinal member joint portions 93B, the rear longitudinal members 91 can be supported reliably. Thereby, the rear longitudinal members 91 can sufficiently resist a relatively large lateral force in an early stage of the load input. Since the vertical width of each second extension 93C decreases gradually toward the laterally outward direction, the concentration of stress on the second extension 93C can be suppressed. By making the bend of the upper surface bent parts 93E more gentle than the bend of the lower surface bent parts 93H, the lateral force applied from the rear longitudinal members 91 to the second rear cross member 93 can be transmitted efficiently to the rear side frames 71.

The left and right front longitudinal members 23 of the front subframe 6 extend obliquely so as to approach each other toward the rear, and therefore, the load applied to the front subframe 6 at the time of a frontal collision can be transmitted in an inward direction obliquely relative to the left and right front side frames 4, whereby the load can be dispersed.

If a load is applied to the front longitudinal members 23 at the time of a frontal collision, the front longitudinal members 23 bend downward at the respective deformation promoting portions 53. As a result, stress is applied to the rear-end supports 21 and the bolts 29B, and the fastening structure between the rear end of each front longitudinal member 23 and the corresponding rear-end support 21 is disrupted so that the front subframe 6 can break away from the rear-end support 21 smoothly. Since the reinforcing plate 54, the front stabilizer support portion 56, the front cross member 24, and the front lower arm support portion 36 are provided in front of and behind each deformation promoting portion 53, the stiffness of the deformation promoting portion 53 is relatively low. Thereby, the stress tends to concentrate on the deformation promoting portion 53, and thus, the deformation preferentially starts from the deformation promoting portion 53.

Since the rear side frame bent parts 71B are positioned to a lateral side of the corresponding rear damper mounts 112, the rear side frame bent parts 71B are reinforced by the rear damper mounts 112, and the rear side frame bent parts 71B are made resistant to bending under the load at the time of a rear collision.

Because the rear ends of the shock-absorbing structures 130 protrude more rearward than the rear end of the rear subframe 72 (the protrusion 93L), the rear subframe 72 receives the load at the protrusion 93L thereof after the shock-absorbing structures 130 absorb the load. Therefore, when the collision load is relatively small, the load is absorbed by the deformation of the shock-absorbing structures 130 and is prevented from being easily transmitted to the rear subframe 72. Thus, the deformation of the rear subframe 72 is suppressed. On the other hand, when the collision load is large, the load is transmitted from the protrusion 93L to the rear subframe 72 so that the load applied to the rear side frames 71 can be dispersed.

When the collision load is relatively small, the load is absorbed by the first shock-absorbing members 131, and when the collision load is large, the load is absorbed by the second shock-absorbing members 132. Because the shock-absorbing structures 130 are positioned more rearward than the electric motor 75, the load at the time of a rear collision is applied to the electric motor 75 after being absorbed by the shock-absorbing structures 130.

Because the protrusion 93L of the second rear cross member 93, which forms the rear end of the rear subframe 72, is positioned more rearward than the rear end of the electric motor 75, a load in a rear collision is more likely to be applied to the rear subframe 72 than to the electric motor 75. Since the electric motor 75 is disposed on the rear part of the rear subframe 72, it is possible to secure a space in front of the electric motor 75. High voltage devices, such as a converter, can be mounted in the space. In addition, this space can be used as a space (escape space) into which the electric motor 75 can move at the time of a rear collision, whereby the collision between the battery 140 and the electric motor 75 can be suppressed. The cutout 88A provided in the lower edge of the rear panel 88 allows the protrusion 93L of the rear subframe 72 to protrude to the rear of the rear panel 88 without interfering with the rear panel 88.

By positioning the rear end of the protrusion 93L rearward of the rear ends of the rear side frames 71, the electric motor 75 can be disposed at a more rearward position in the vehicle body structure 1 so that a space can be secured in front of the electric motor 75. In addition, the load applied to the rear side frames 71 due to rear collision can be transmitted from the protrusion 93L to the rear subframe 72 so that the load applied to the rear side frames 71 can be dispersed.

Since the rear edge of the second rear cross member 93 extends from the protrusion 93L forward and laterally outward in an oblique manner toward each of the left and right fourth rear subframe-side attachment portions 104, the load applied to the central part of the second rear cross member 93 from the rear can be transmitted efficiently to the left and right rear side frames 71.

The protrusion 93L of the rear subframe 72 is positioned forward of the rear ends of the shock-absorbing structures 130 and rearward of the front ends of the same, the second rear cross member 93 receives the load at the protrusion 93L after the shock-absorbing structures 130 absorbs the load. Therefore, a relatively small collision load is absorbed by the shock-absorbing structures 130 and is prevented from being easily transmitted to the rear subframe 72. Thereby, the deformation of the rear subframe 72 is suppressed. On the other hand, when the collision load is large, the load is transmitted from the protrusion 93L to the rear subframe 72 so that the load applied to the rear side frames 71 can be dispersed.

The front subframe 6 in the present embodiment has the front lower arm supports 36 at parts thereof having an improved stiffness owing to the front cross member 24. Therefore, although the front longitudinal members 23 include the deformation promoting portions 53 and have a curved shape to widen a steering space for the front wheels 5, the front subframe 6 can be made resistant to deformation under a lateral force applied thereto via either lower arm 31. Thereby, ride comfort and driving performance can be improved. Because the front longitudinal members 23 can be curved laterally inward so that wide spaces in which the front wheels 5 are steered can be secured on laterally outer sides of the front subframe 6, it is possible to achieve a large steering angle range of the front wheels 5.

Because the front lower arm supports 36 are provided at portions of the front subframe 6 overlapping the front cross member 24 in the lateral direction, the front subframe 6 can be made even more resistant to deformation under the lateral force applied via either lower arm 31.

Since each front lower arm support portion 36 is joined to the corresponding front longitudinal member 23 and the front cross member 24, the stiffness of the front lower arm support portion 36 is improved. Thereby, the front subframe 6 can support the lower arms 31 reliably. In addition, this increases the difference in stiffness between the deformation promoting portion 53 of each front longitudinal member 23 and the part of the front longitudinal member 23 rearward of the deformation promoting portion 53 where the front cross member 24 and the front lower arm support portion 36 are provided, and therefore, the front longitudinal member 23 can deform reliably at the deformation promoting portion 53 at the time of a frontal collision.

Since each front lower arm support portion 36 is joined to the corresponding front side frame 4, the stiffness of the front lower arm support portion 36 is improved even further. In addition, the lateral force applied to the front lower arm support portion 36 from the corresponding lower arm 31 can be transmitted to the front side frame 4. Moreover, the slanted portion 36D of each front lower arm support portion 36 allows the load to be transmitted efficiently from the front longitudinal member 23 and the front cross member 24 to the front side frame 4. An end of the slanted portion 36D is positioned at a part of the front cross member 24 having stiffness improved by the collar 47, and therefore, the load can be transmitted efficiently from the front cross member 24 to each front side frame 4. Further, the steering gearbox 40 contributes to improving the stiffness of the front cross member 24.

The brace 26 improves the stiffness of the front subframe 6. Likewise, the front stabilizer 55 improves the stiffness of the front subframe 6. Owing to these features, the front subframe 6 can be made resistant to deformation under the lateral force applied thereto via either lower arm 31.

At the time of frontal collision, the front crash boxes 12 deform first to absorb the load, and therefore, when the collision load is small, the deformation promoting portion 53 is prevented from deforming. Thereby, replacement of the front subframe 6 can be avoided.

Concrete embodiments of the present invention have been described in the foregoing, but the present invention should not be limited by the foregoing embodiments and various modifications and alterations are possible within the scope of the present invention.

### REFERENCE NUMERALS

1: vehicle body structure
3: side sill
4: front side frame
6: front subframe
23: front longitudinal member
24: front cross member
26: brace
31: lower arm
36: front lower arm support portion
40: steering gear box
44: joint portion
51: rear lower arm support portion
53: deformation promoting portion
55: front stabilizer
56: front stabilizer support portion
71: rear side frame
72: rear subframe
75: electric motor
77: vehicle body cross member
78: rear floor panel
80: load transmitting member
81: bulkhead wall
91: rear longitudinal member
92: first rear cross member
93: second rear cross member
93C: the second extension
93L: protrusion
130: shock absorbing structure
131: first shock absorber
132: second shock absorber
140: battery

1. A vehicle body structure, comprising:
a pair of side sills extending in a fore and aft direction on either side of a vehicle;
a pair of front side frames extending in the fore and aft direction along either side of a front part of the vehicle, and connected to front ends of the side sills at rear ends thereof, respectively;
a pair of rear side frames extending in the fore and aft direction along either side of a rear part of the vehicle, and connected to rear ends of the side sills at front ends thereof, respectively;
a front subframe attached to the front side frames;
a rear subframe attached to the rear side frames; and
a battery positioned in a region surrounded by the side sills, the front subframe and the rear subframe in plan view,
wherein one of the front subframe and the rear subframe supports a drive unit, while another of the front subframe and the rear subframe does not support the drive unit, and is attached to the front side frames or the rear side frames, as the case may be, so as to be detachable under a crash load.

2. The vehicle body structure according to claim 1, wherein the front subframe includes a pair of front longitudinal members extending in the fore and aft direction on either side thereof, each front longitudinal member being provided with a front end attaching portion attached to the corresponding front side frame at a front end thereof, and the rear subframe includes a pair of rear longitudinal members extending in the fore and aft direction on either side thereof, each rear longitudinal member being provided with a rear end attaching portion attached to the corresponding rear side frame at a rear end thereof.

3. The vehicle body structure according to claim 1, wherein one of the front subframe and the rear subframe supporting the drive unit is provided with a pair of subframe longitudinal members extending in the fore and aft direction along either side thereof, and a subframe cross member extending laterally between the subframe longitudinal members and attached to the front side frames or the rear side frames, as the case may be.

4. The vehicle body structure according to claim 3, wherein the front side frames and the rear side frames are each provided with a longitudinal extension extending in the fore and aft direction, and a rear or front end of the longitudinal extension is provided with an oblique portion extending laterally outward and rearward or forward, as the case may be, to be connected to a corresponding end part of the corresponding side sill.

5. The vehicle body structure according to claim 4, further comprising a vehicle body cross member extending laterally between the oblique portions of the front side frames or the rear side frames corresponding to one of the front subframe and the rear subframe supporting the drive unit, and
a pair of load transmitting members each extending from the longitudinal extension of the corresponding front side frame or the corresponding rear side frame associated with one of the front subframe and the rear subframe supporting the drive unit to the vehicle body cross member via a laterally inboard side of the corresponding oblique member.

6. The vehicle body structure according to claim 5, wherein the load transmitting members are inclined laterally inward from the respective longitudinal extensions toward the vehicle body cross member.

7. The vehicle body structure according to claim 5, wherein the drive unit is supported by the rear subframes, a floor panel is supported by upper surfaces of the rear side frames, and the load transmitting members each form a closed cross section structure jointly with the corresponding rear side frame and the floor panel.

8. The vehicle body structure according to claim 7, wherein each closed cross section structure formed by the load transmitting member, the rear side frame and the floor panel is internally provided with a bulkhead connected to the load transmitting member and the rear side frame, and
the subframe longitudinal members of the rear side frames are each attached to a vehicle body side mounting portion including the bulkhead.

9. The vehicle body structure according to claim 8, wherein each vehicle body side mounting portion includes a collar that extends vertically and connected to the load transmitting member and the bulkhead.

10. The vehicle body structure according to claim 3, wherein the subframe cross member includes a pair of longitudinal member connecting portions connected to the respective subframe longitudinal members, a pair of cross member extensions extending laterally outward and upward from the respective longitudinal member connecting portions, and a pair of outer end mounting portions attached to the corresponding front side frames or the corresponding rear side frames.

11. The vehicle body structure according to claim 10, wherein a vertical width of the subframe cross member is at a maximum value at the longitudinal member connecting portions.

12. The vehicle body structure according to claim 11, wherein a vertical width of each cross member extension is progressively reduced toward a lateral outer end thereof.

13. The vehicle body structure according to claim 12, wherein each longitudinal member connecting portion includes a through hole passed through the subframe cross member in the fore and aft direction, and the corresponding subframe longitudinal member is inserted in the through hole, and is welded to the subframe cross member.

14. The vehicle body structure according to claim 10, wherein the subframe cross member is provided with an upper surface central portion having a surface facing upward and extending laterally, a pair of upper surface inclined portions each extending from a corresponding end of the upper surface central portion via an upper surface curved portion, a lower surface central portion having a surface facing downward and extending laterally, and a pair of lower surface inclined portions each extending from a corresponding end of the lower surface central portion via a lower surface curved portion,
the upper surface curved portions being position laterally inward of the longitudinal member connecting portions, and the lower surface curved portions being position laterally outward of the longitudinal member connecting portions.

15. The vehicle body structure according to claim 14, wherein the subframe cross member is provided with an upper member having a channel shaped cross section with an open side facing downward, and a lower member having a channel shaped cross section with an open side facing upward, and forming a closed cross section structure jointly with the upper member, and
the upper member forms the upper surface central portion, the upper surface curved portions, and the upper surface inclined portions while the lower member forms the lower surface central portion, the lower surface curved portions, and the lower surface inclined portions.

16. The vehicle body structure according to claim 14, wherein each lower surface inclined portion includes a reinforcing bead extending from the corresponding lower surface curved portion toward the outer end mounting portion.

17. The vehicle body structure according to claim 10, further comprising a rear panel extending laterally and connected to rear end parts of the rear side frames.

18. The vehicle body structure according to claim 17, wherein the rear panel is provided with a recess which is recessed upward in a lower edge part thereof.

19. The vehicle body structure according to claim 1, wherein the front subframe includes a pair of front longitudinal members extending in the fore and aft direction on either lateral side thereof, and a front subframe cross member extending laterally between the front longitudinal members, the front longitudinal members being inclined so as to come toward each other toward rear ends thereof.

20. The vehicle body structure according to claim 19, further comprising a pair of front subframe rear end support portions provided on the laterally inner sides of the respective front side frames,
wherein each front subframe rear end support portion is provided with a fastening portion to which the corresponding front side frame is fastened, and a guide portion positioned behind the fastening portion and having an inclined surface inclining downward toward a rear side, and
each front longitudinal member is fastened to the corresponding fastening portion from below by a bolt at a rear side fastening portion thereof positioned a certain distance in front of a rear end thereof.

21. The vehicle body structure according to claim 20, wherein a part of each front longitudinal member located in front of the rear side fastening portion is provided with a deformation promoting portion providing a starting point of downward deformation when a predetermined load is applied from the fore and aft direction.

22. The vehicle body structure according to claim 21, wherein each deformation promoting portion is provided with a recessed portion formed on an upper surface of the corresponding front longitudinal member.

23. The vehicle body structure according to claim 22, wherein each deformation promoting portion includes a high rigidity portion having a higher rigidity than the recessed portion in front of and behind the recessed portion.

24. The vehicle body structure according to claim 23, wherein one of the high rigidity portions includes a stabilizer attachment portion for supporting a front stabilizer, and a cross member connecting portion to which an end of the front subframe cross member is connected.
